(19) United States
(12) Patent Application Publication
(10) Pub. No.: US 2012/0075433 A1
(43) Pub. Date: Mar. 29, 2012

(54) EFFICIENT INFORMATION PRESENTATION FOR AUGMENTED REALITY

(75) Inventors: Markus Tatzgern, Graz (AT); Denis Kalkofen, Graz (AT); Dieter Schmalstieg, Graz (AT)

(73) Assignee: QUALCOMM INCORPORATED, San Diego, CA (US)

(21) Appl. No.: 13/225,302

(22) Filed: Sep. 2, 2011

Related U.S. Application Data
(60) Provisional application No. 61/380,641, filed on Sep. 7, 2010.
(60) Provisional application No. 61/490,739, filed on May 27, 2011.

(51) Int. Cl. G09G 5/00; H04N 13/02; G06T 17/00

(52) U.S. Cl. 348/50; 345/633; 345/420; 348/E13.074

(57) ABSTRACT

Information to be displayed is filtered to reduce the amount of information which has to be arranged on screen to increase comprehensibility. The filter preserves the information encoded in the visualization by removing redundant elements by first clustering similar elements and then selecting a single representative from each cluster. Additionally, the layout of the information is optimized based on an evaluation of element comprehensibility in order to achieve a compact presentation suitable for small screen devices. The compact presentation of data may be updated on a mobile platform with real-time frame rates by pre-computing multiple view points and displaying a frame coherent transition between layouts, so that temporal coherency is retained during camera movements.

### CROSS-REFERENCE TO PENDING PROVISIONAL APPLICATION

This application claims priority under 35 USC 119 to U.S. Provisional Application No. 61/380,641, filed Sep. 7, 2010, and entitled “Annotated Compact Explosion Diagrams”, and U.S. Provisional Application No. 61/490,739, filed May 27, 2011, entitled “Efficient Information Presentation for Augmented Reality”, both of which are assigned to the assignee hereof and are incorporated herein by reference.

### BACKGROUND

Augmented Reality (AR) displays are able to present computer generated data registered to real world objects and places. A typical AR application guides scene exploration by providing contextual data in the form of textual, iconic or pictorial elements corresponding to real world features. For example, recent commercial applications, such as Wikitude or Layar, present geo-referenced 2D content overlaid on top of the system's video feed. Moreover, AR exploratory systems are not limited to augmentations of 2D content. For example, 3D explosion diagrams have been demonstrated as a useful visualization aid in AR, enabling in-situ analysis of the assembly of real world objects.

While AR displays enrich the exploration of a scene with additional information, care has to be taken in an already complex real world environment. Naively overlaying a large amount of information on top of the real world image may easily cause a number of cognitive problems. For instance, elements of the scene may occlude each other or may hide important landmarks in the environment.

Existing approaches for the generation of layers work only for small amounts of information. With an increasing amount of information, known layout algorithms result in suboptimal placement for certain items. Moreover, with an increasing competition for empty areas, the resulting presentation becomes increasingly unstable in the time domain, resulting in items that jump from one location to another in the display.

It is not realistic to assume that AR scenes will be limited to a small number of items. Social AR applications, which rely on legacy databases, such as geographic information systems, or crowdsourcing of content, can provide an arbitrary density of information items for popular subjects or locations. Another source of annotations is the automatic generation of information tags after image segmentation and recognition. In all these cases, image clutter can easily be the result of attempting to present the available information in an unfiltered way.

### SUMMARY

Information to be displayed is filtered to reduce the amount of information which has to be arranged on screen to increase comprehensibility. The filter preserves the information encoded in the visualization by removing redundant elements by first clustering similar elements and then selecting a single representative from each cluster. Additionally, the layout of the information is optimized based on an evaluation of element comprehensibility in order to achieve a compact presentation suitable for small screen devices. The compact presentation of data may be updated on a mobile platform with real-time frame rates by pre-computing multiple view points and displaying a frame coherent transition between layouts, so that temporal coherency is retained during camera movements.

In one implementation, a method includes receiving data information to be displayed; clustering the data information into groups of similar elements; calculating a quality measure for each element in each group; generating a layout with a representative element from each group selected based on the quality measure; optimizing the layout by replacing the representative element from at least one group based on the quality measure to produce a final layout; and providing the final layout to be displayed.

In another implementation, an apparatus includes memory storing data information to be displayed and a processor coupled to the memory. The processor is configured to cluster the data information into groups of similar elements, calculate a quality measure for each element in each group, generate a layout with a representative element from each group selected based on the quality measure, optimize the layout by being configured to replace the representative element from at least one group based on the quality measure to produce a final layout, and to store the final layout to be displayed.

In another implementation, an apparatus includes means for receiving data information to be displayed; means for clustering the data information into groups of similar elements; means for calculating a quality measure for each element in each group; means for generating a layout with a representative element from each group selected based on the quality measure; means for optimizing the layout by replacing the representative element from at least one group based on the quality measure to produce a final layout; and means for providing the final layout to be displayed.

In yet another implementation, a non-transitory computer-readable medium including program code stored thereon includes program code to cluster data information to be displayed into groups of similar elements; program code to calculate a quality measure for each element in each group; program code to generate a layout with a representative element from each group selected based on the quality measure; program code to optimize the layout by being configured to replace the representative element from at least one group based on the quality measure to produce a final layout; and program code to store the final layout to be displayed.

In another implementation, a method includes receiving a three-dimensional model of an object with different layouts based on viewing angle; capturing a first image of the object at a first viewing angle; determining the first viewing angle with respect to the object; selecting and displaying a first layout of the three-dimensional model based on the first viewing angle; capturing a second image of the object at a second viewing angle; determining the second viewing angle with respect to the object; selecting a second layout of the three-dimensional model based on the second viewing angle; and displaying a frame coherent transition from the first layout to the second layout.

In another implementation, a mobile platform includes a camera for imaging an object; memory for storing a three-dimensional model of the object with different layouts based on viewing angle; a display; and a processor coupled to the camera, the memory, and the display. The processor is configured to determine a first viewing angle with respect to the object from a first image of the object captured by the camera, select a first layout of the three-dimensional model based on the first viewing angle and causing the display to display the first layout, determine a second viewing angle with respect to the object from a second image of the object captured by the camera, select a second layout of the three-dimensional model based on the second viewing angle and causing the display to display a frame coherent transition from the first layout to the second layout.

In another implementation, a mobile platform includes means for receiving a three-dimensional model of an object with different layouts based on viewing angle; means for capturing a first image of the object at a first viewing angle; means for determining the first viewing angle with respect to the object; means for selecting and displaying a first layout of the three-dimensional model based on the first viewing angle; means for capturing a second image of the object at a second viewing angle; means for determining the second viewing angle with respect to the object; means for selecting a second layout of the three-dimensional model based on the second viewing angle; and means for displaying a frame coherent transition from the first layout to the second layout.

In yet another implementation, a non-transitory computer-readable medium including program code stored thereon includes program code to determine a viewing angle with respect to an object from a first image of the object captured by a camera; program code to select a layout of the three-dimensional model based on the viewing angle; program code to cause the display to display the layout selected based on the viewing angle; and program code to display to display a frame coherent transition between different layouts.

### BRIEF DESCRIPTION OF THE DRAWING

FIG. 1 illustrates a block diagram showing a system including a mobile platform capable of efficient information presentation that may be used for augmented reality.

FIG. 2 is a flow chart of illustrating a method of generating comprehensible layouts from a large database.

FIG. 3 illustrates a cluttered layout that is processed to produce a comprehensible layout.

FIG. 4 is a flow chart illustrating method of optimization of a layout.

FIGS. 5A and 5B illustrate a simple object with different layouts, with the left portion exploded and the right portion exploded, respectively.

FIGS. 5C and 5D illustrate displaying different manners of displaying the layouts from FIGS. 5A and 5B.

FIGS. 6A-6C illustrates a conventional disassembly sequence based on bounding box intersections

FIGS. 7A-7C illustrate a disassembly sequence based on a comparison of the previously exploded part and dissembling all similar parts in the remaining assembly.

FIGS. 8A-8C illustrate relations assigned between parts in a model in which there are intermediate parts.

FIGS. 9A-9E illustrate a model that includes one set of four similar subassemblies and different manners of generating explosion diagram layouts.

FIG. 10 is a block diagram of an apparatus capable of generating comprehensible layouts from a large database.

FIG. 11 is a flow chart illustrating a method of displaying dynamic layouts as the pose between the mobile platform and the target object changes.

FIG. 12 is a block diagram of a mobile platform capable of displaying dynamic layouts as the pose changes between the mobile platform and a target object.

### DETAILED DESCRIPTION

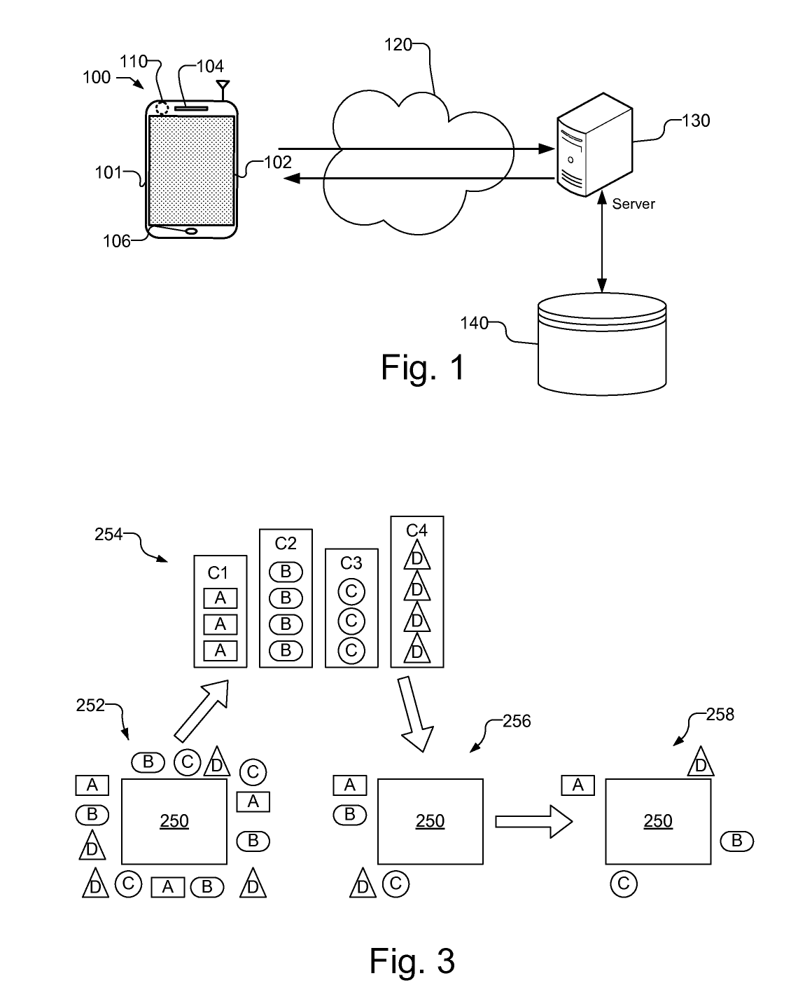

FIG. 1 illustrates a block diagram showing a system including a mobile platform 100 capable of efficient information presentation for augmented reality. The mobile platform 100 is illustrated as including a housing 101, a display 102, which may be a touch screen display, as well as a speaker 104 and microphone 106. The mobile platform 100 further includes a camera 110 to image the environment.

As used herein, a mobile platform refers to any portable electronic device such as a cellular or other wireless communication device, personal communication system (PCS) device, personal navigation device (PND), Personal Information Manager (PIM), Personal Digital Assistant (PDA), or other suitable mobile device. The mobile platform may be capable of receiving wireless communication and/or navigation signals, such as navigation positioning signals. The term “mobile platform” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile platform” is intended to include all electronic devices, including wireless communication devices, computers, laptops, tablet computers, etc. which are capable of AR.

Within the system, the mobile platform 100 and/or a remote server 130 are capable of receiving data information to be displayed, clustering and filtering the information and generating an optimized layout of the information to be displayed by the mobile platform 100. When the remote server 130 generates the layout of the information, the mobile platform 100 obtains the data to be displayed from the server 130 via a network 120. The server 130 may include a database 140, which stores the information and layouts and provides the information to mobile platform 100 via network 120 as needed.

The network 120 may be any wireless communication networks such as a wireless wide area network (WWAN), a wireless local area network (WLAN), a wireless personal area network (WPAN), and so on. The terms “network” and “system” are often used interchangeably. The terms “position” and “location” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a Long Term Evolution (LTE) network, a WiMAX (IEEE 802.16) network and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be implemented in conjunction with any combination of WWAN, WLAN and/or WPAN.

The information displayed as explorative AR displays by the mobile platform 100 has increased comprehensibility as it has been filtered to reduce the amount of information which has to be arranged on screen. The filtering of the information considers the point of view of the user, e.g., the position and orientation (pose) of the mobile platform 100 with respect to the real-world object, as well as the type of information. The filter preserves the information encoded in the visualization by removing redundant elements. During filtering, the resulting presentation is simultaneously optimized by selecting elements based on an analysis of their comprehensibility as a member of a layout.

Additionally, the placement of the information is optimized using an automatic layout generation, which depends on an evaluation of element comprehensibility. The layout generation achieves a compact presentation on small screen devices, such as mobile platform 100, which avoid self and scene occlusions. Further, the compact presentation may be updated with real-time frame rates, in which compact presentations from neighboring points of view are aligned, so that temporal coherency is retained during camera movements.

To generate comprehensible layouts from a large database, the amount of information to be arranged on the display is reduced. In order to avoid a loss of information encoded in the data, only redundant elements should be removed so that the remaining elements faithfully represent the original database. Thus, the database is filtered by first clustering similar elements and then selecting a single representative from each cluster. Additionally, the comprehensibility of the selected elements is validated, and the selection is potentially modified so that the resulting layout will meet desired quality parameters. The result is a compact visualization that encodes the information from the database using a minimal amount of elements on the screen.

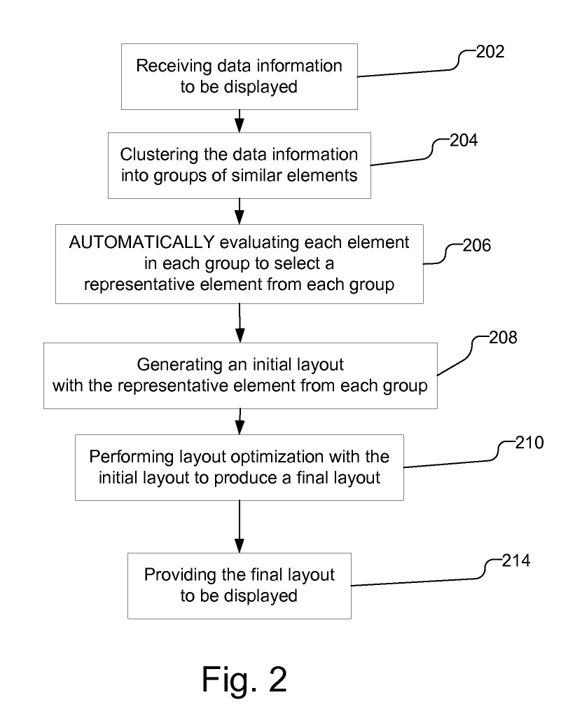

FIG. 2 is a flow chart of illustrating a method of generating comprehensible layouts from a large database. As illustrated, the data information that is to be displayed is received (202), e.g., by the mobile platform 100 or the server 130. In order to reduce the information to be arranged on a screen, the data information is filtered to remove redundant elements by searching for elements that can be combined to a single displayed item. Thus, the data information is clustered into groups of similar elements (204) and each element within each group is automatically evaluated to select a representative element from each group (206).

FIG. 3, by way of example, illustrates a cluttered layout 252 of an object 250 and that includes a number of similar types of associated elements, labeled “A”, “B”, “C”, and “D”. The associated elements A, B, C, and D are clustered into a different cluster groups 254, labeled “C1”, “C2”, “C3”, and “C4”, respectively. Clustering may be achieved in different ways and may be dependent on the type of layout being generated. For example, for explosion diagrams, clustering may be performed using shape descriptors, and a graph representation of the assemblies derived from the parts and the contacts between the parts, and a frequent sub graph search on the graph, as described in more detail below. Textual annotations may be clustered based on searching for simple string similarity, e.g., the beginning of the text is the same, and analyzing the annotated three-dimensional (3D) geometry using a procedure similar to that used for explosion diagrams, e.g., shape descriptors and a graph search, and mapping the results to the text annotations. For image data, a combination of Scale Invariant Feature Transform (SIFT) features and global GIST descriptions may be used to find images showing similar content. For example, for automatic recognition in building façades, a predefined database of SIFT features for objects may be used, which allows classification of the detected objects in the image. Each element E, in each cluster group is then evaluated to predict its comprehensibility to present the desired information, e.g., by computing a quality measure Qⱼᵢ. The quality measure Qⱼᵢ for comprehensibility is dependent on the type of data information to be displayed. For example, in explosion diagrams, the direction of element displacement is an important measure of comprehensibility, while textual labels must be placed close to the referred structure. The quality measure Qⱼᵢ for comprehensibility may be based on, e.g., a combination of the distance from the structure that they are associated with and visibility so that the relationship between the element and the object will be clearly presented.

Referring back to FIG. 2, after analyzing the comprehensibility of all elements in all cluster groups, an initial layout is generated using the representative element from each group (208). The initial layout is formed, e.g., using the element selected from each cluster as having the most comprehensible presentation. A naive selection of representative elements after clustering, however, does not consider whether the corresponding 3D structures are occluded, too small or violate other comprehensibility parameters. FIG. 3, by way of example, illustrates an initial layout 256 using a representative element from each cluster group. As illustrated in FIG. 3, the elements “A” and “B” and the elements “C” and “D” are displayed close together, which may affect comprehensibility.

Accordingly, a layout optimization is performed based on the initial layout to produce a final layout (210), which is provided to be displayed (212), e.g., by storing in memory. The layout optimization process optimizes the comprehensibility parameters of the displayed elements as well as the quality of the overall layout. In the layout optimization process the comprehensibility of each element is reexamined with respect to its contribution to the overall layout. Elements that adversely affect the layout are substituted with another representative from their cluster groups in an incremental process that optimizes for overall comprehensibility. The selection process for representatives may be randomized. Thus, for example, different layouts may be repeatedly generated with different selected representative elements from each group and a global quality measure is calculated for each different layout. The final layout is selected based on the global quality measure for each different layout. The optimization process may also consider global parameters, such as the variation of label distances. FIG. 3 illustrates a final layout 258 after layout optimization, in which the individual elements appear uniformly distributed around the object 250 to increase comprehensibility.

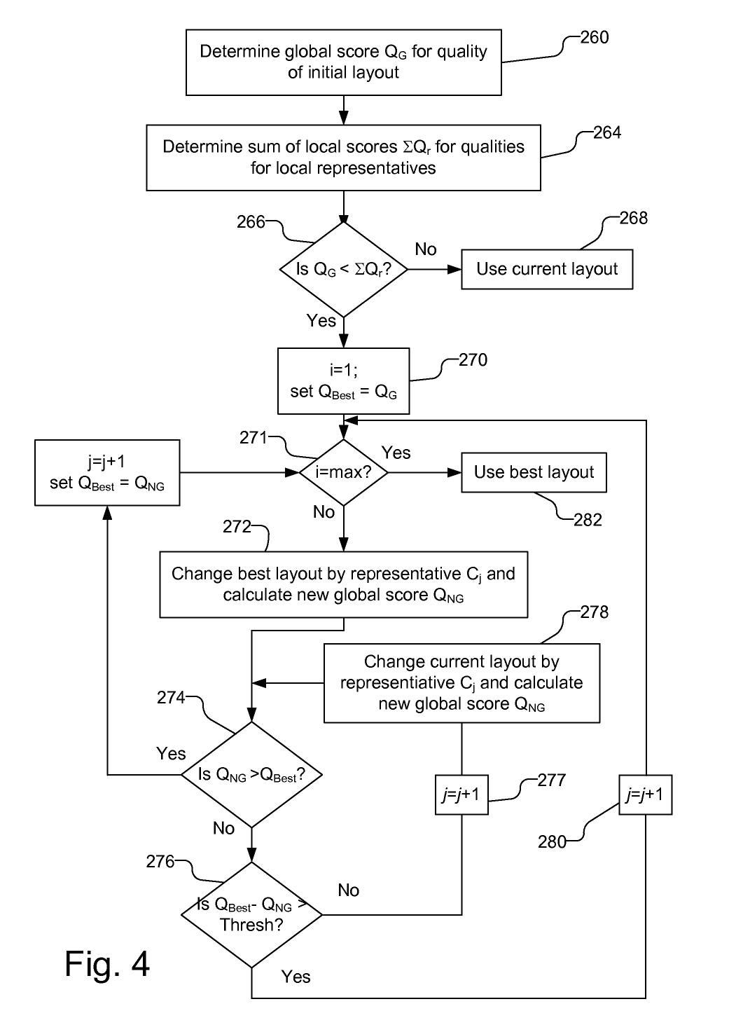

FIG. 4 is a flow chart illustrating method of optimization of the layout. In general, during the optimization of the layout different layouts may be repeatedly generated with different selected representative elements from each group and a global quality measure is calculated for each different layout. The final layout is selected based on the global quality measure for each different layout. As illustrated in FIG. 4, a global score Q_{G} for the quality of the initial layout is calculated (260) based on the display of all of the selected representative elements. The global score for quality may be calculated in a manner similar to the quality determination for each individual element in each quality. The sum of the local scores ΣQᵣ for the quality of each representative element in the layout is calculated (262) and compared to the global score Q_{G} (264). The initial layout consists of selected representatives with the highest local scores for quality. Therefore, if the sum of the local scores ΣQᵣ is equal to the global score Q_{G} (266), the selected representative elements may be used as the global representatives and the current layout is used as the final layout (268). However, if the global score Q_{G} is less than the sum of local scores ΣQᵣ, a threshold accepting process is initiated setting the best score Q_{Best} as the global score Q_{G} for the initial layout (270). The threshold accepting process runs for a predetermined number of iterations i (270) and (271). During the threshold accepting process, the best layout, which is initially the initial layout, is changed by a single representative group Cⱼ and a new global score Q_{NG} is computed for the new layout (272). If the new global score Q_{NG} for the changed layout is higher than the best score Q_{Best}, (274), the new layout is considered the best layout, the best score Q_{Best} is set as the new global score Q_{NG} and j=j+1 (275) and the process proceeds back to step 271, where the best layout is modified by the next representative group Cⱼ (272), unless the threshold accepting process has run the maximum number of iterations i (271). On the other hand, if the new global score Q_{NG} is equal or less than the best score Q_{Best} (274), the current layout will not be selected to be displayed. However, even if the new global score Q_{NG} is equal or less than the best score Q_{Best} (274), the layout may be further modified based on the current layout if the difference between the global score Q_{Best} and the new global score Q_{NG} is less than a threshold (276). In other words, if the difference between the best score Q_{Best} and the new global score Q_{NG} is less than a threshold, the current layout is further modified by the next representative group Cⱼ (277 and 278) and a new global score Q_{NG} is again calculated before proceeding to step 274. Otherwise, the process proceeds back to step 272 where the best layout is modified by the next representative group Cⱼ (280). If desired, as the process progresses, the threshold value used in step 276 may decrease, which gradually allows better layouts to be the starting point for further changes. If the threshold accepting process has run the maximum number of iterations i (271), the current best layout is used as the layout (282). If at any time during the process, all of the representatives Cⱼ have been modified prior to the maximum number of iterations for the process, the process may be ended with the current best layout selected as the layout (282).

Additionally, the distribution of representative elements may be constrained to enforce certain layout strategies. For example, elements may be grouped into sub-structures, which may be constrained to be displayed together. For example, in a model of a building, all parts of a particular window belong to the same window group. When the algorithm chooses representative elements from the cluster groups “window boards” and “window blinds”, these representative elements may be chosen from the same window group.

The general method of process of generating comprehensible layouts from a large database as described in FIG. 2 may be refined for use with particular AR type applications, including but not limited to annotation of structures and images, explosion diagrams, and photo collections, such as geo-referenced photo collections and two-level compact photo collections. The application of the method of FIG. 2 with respect to several different type of specific AR application is described further below.

Common problems suffered in AR visualization include the minimal extent of layouts and frame coherence. In order to generate layouts with minimal extent, the size of the screen aligned bounding box for each layout is computed during layout optimization. The quality of a layout is proportional to the inverse of the size of the screen aligned bounding box. Generating a visualization with minimal extent allows zooming closer to the object of interest, which in turn allows larger presentation of each element with higher detail.

Additionally, by maximizing the distances between screen elements, the resulting layouts consist of elements, which are less prone to collisions from nearby viewpoints. This layout may be achieved by maximizing the sum of all distances, the maximal distance and the minimal distance. The distances can be measured in 2D screen coordinates or spatial 3D positions. This combined value is used as a quality measure for a layout during layout optimization.

In practice, scalable AR applications use databases that are not handcrafted, but rather the result of automatic processing, such as image segmentation and recognition, or created by crowdsourcing. The applications presented herein assume such databases, which are well known. However, it should be noted that the databases discussed herein are for illustration purposes, and automatic creation of large AR databases is not in the scope of this document.

Annotating 3D Structures:

In the annotation of 3D structures, the data information is a real world object or location given as a hierarchical CAD model composed of many parts, each annotated with a textual label. To create a compact representation, one representative for each annotation cluster is selected.

Clustering. Model parts are clustered by similarity, which may be determined, e.g., by comparing the shape descriptors of parts, or by comparing the determined semantics. Semantics rely on previous knowledge of (similar) parts. For instance, a database of 3D parts may be built up, including shape descriptors and semantics. When a new 3D object is analyzed, its shape descriptor can be used to query the predefined database. If a similar part is retrieved from the predefined database, the semantic of the new object may be derived from the semantics of similar part. By way of example, shape analysis may be performed, e.g., based on the DESIRE shape descriptor, such as that described by D. V. Vranic in “Desire: A composite 3d-shape descriptor”, In Proceedings of the IEEE International Conference on Multimedia and Expo, pages 962-965, 2005, which is incorporated herein by reference. Real world locations may be derived from the 3D CAD data by registering the 3D object within the real world environment. Furthermore, the frequent subgraph search on the graph representation of the 3d structure, permits identification of similar groups of parts. The group information can be used to control the representative selection by choosing only representatives, which are in the same group, so that the labels are not spread apart.

Selection of Representatives. For each desired pose with respect to the object, a representative label is selected from each cluster, e.g., according to size and visibility of the referred part and to the distance from the label to part, e.g., the distance between the label and the anchor point on the part. The closer a label is placed to the part and the more this part is visible, the easier it is to understand the relation between label and part. The initial label placement is computed using the force based approach while disabling collision avoidance between labels, as described by K. Ali, K. Hartmann, and T. Strothotte in “Label Layout for Interactive 3D Illustrations”, Journal of the WSCG, 13(1):1-8, jan/feb 2005, which is incorporated herein by reference.

The distance from the label to the referred part is computed relative to the size of the overall structure. The label is placed outside the 2D bounding box of the overall structure in a flushed layout as described by K. Hartmann, T. Gotzelmann, K. Ali, and T. Strothotte, in “Metrics for functional and aesthetic label layouts”, In Proc. of International Symposium on Smart Graphics, pages 115-126, 2005, which is incorporated herein by reference. The quality measure of the label placement Distance, is then normalized by dividing the displacement from the Part Center to the LabelPosition by the screen diagonal.

The overall quality of a label and its corresponding 3D structure is computed using Equation 1, below. The number of visible pixel NumVisiblePixel, of the label is computed by considering occlusions from other scene elements, while NumTotalPixel, refers to the total number of pixels after projecting the label to screen space. To control the ratio between visibility and size, weights w_{d}, wᵥ, and wᵣ are introduced.

$${QualityLabel}_{i} = {w}_{d} * {Distance}_{i} + {w}_{v} * \frac{{NumVisiblePixel}_{i}}{{NumTotalPixel}_{i}} + {w}_{r} * \frac{{NumTotalPixel}_{i}}{Resolution} \\ {Distance}_{i} = \frac{\sqrt{δ {x}^{2} + δ {y}^{2}}}{\sqrt{{ImageWidth}^{2} + {ImageHeight}^{2}}} \\ δ {x}^{2} = LabelPositionx - PartCenterx \\ δ {y}^{2} = LabelPositiony - PartCentery \\ Resolution = ImageWidth * ImageHeight \qquad eq . 1$$

Layout optimization. The overall layout optimization aims for overlap-free and even distribution of labels. For each pair of adjacent labels, as uniquely determined by their flushed layout, their 2D Euclidean distance and their deviation from the mean distance are computed using Equation 2, below. The weights wₗ, w₁, w₂, and w₃ control the bias towards quality of the labels versus quality of their distribution, and AvgNeighborDist is the average distance of neighboring labels, MinNeighborDist is the minimum distance to a neighboring label, and MaxNeighborDist is the maximum distance to a neighboring label.

QualityLayoutⱼ=QualityDist+wₗ*Σᵢ₌₀^{numLabels}QualityLabelᵢ;

QualityDist=(w₁*AvgNeighborDist+w₂*MinNeighborDist+w₃*MaxNeighborDist). eq. 2

Occlusions may be resolved by selecting collision-free representatives from the clusters. However, substituting labels with less comprehensible ones decreases the quality of the layout. Therefore, a label position is allowed to vary from the optimal position within a small distance, at a small penalty proportional to the amount of displacement. Thus, during optimization, comprehensible labels with small offsets are preferred to less comprehensible ones at an optimal position.

Image Based Annotations

If no CAD model of a real world object is available, an AR application may employ object recognition to derive object semantics, which can be converted into automatic annotations. However, automatic recognition can easily lead to clutter in complex scenes. Accordingly, a variation of the label layout for image based annotations may be performed as follows.

Clustering. Recognized objects are clustered, e.g., based on the identified object class.

Selection of Representatives. Within each cluster, objects are ranked based on their screen size, estimated by a 2D bounding box, as discussed above. Thus, the initial set of labels refers to the largest objects in the image. If desired, other parameters may be used, such as the distance to the part.

Layout Optimization. During optimization, labels may be arrange as described above for annotating 3D structures, by first applying forces and then considering a weighted sum of object placement quality and quality of distribution (Equation 2).

In general, object recognition is time consuming and places a constraint on the computation time available for producing a layout. Thus, a number of simplifications may be desirable. For example, the optimization may be stopped after the available time budget for a frame is exceeded. Time consuming computations such as visibility estimation may be omitted. Finally, changes to the layout are only computed when the camera is not moving. For a moving camera, which may be determined based on board motion sensor data, such as accelerometers, gyroscopes, etc., or based on visual tracking techniques, a previous layout may be maintained and the anchor points for the labels tracked using, e.g., Harris Corners, Scale Invariant Feature Transform (SIFT) feature points, Speeded-up Robust Features (SURF), or any other desired method, such as GPU-SIFT3.

Geo-Referenced Photo Collections

Some AR browsers allow exploring geo-referenced photographs. However, current AR browsers suffer from two main problems. The images are only filtered by distance and not by content. Therefore, a number of images of no general interest are presented. Secondly, images are not arranged, which leads to interferences between images, making it hard for users to identify the content or interaction with the images. Some browsers place icons instead of images, which are then selected when they are selected by the user. However, these icons also interfere with each other.

Accordingly, the method described in FIG. 2 can be used to control the clutter resulting from an overload of images. Because images use a lot of screen-space, not all images are shown all the time. Instead, images of a user selected landmark are shown. For all other landmarks, small and simple placeholder icons may be rendered.

When a landmark is selected, the user may be initially presented with a main view, where sub images are arranged around a main image. For each sub image the user can extend sub views, showing additional images to this sub image. Doing so makes the sub image the main image of the sub view. The main image roughly corresponds to the current orientation and position of the user relative to the landmark. The sub images arranged around the main image may show the landmark from other positions, i.e. orientations. The relative position of a sub image around the main image reflects the actual position of the depicted view relative to the main view. Hence, images taken from to the left of the main view are placed to the left, images taken from behind on top. Using this method, images from different positions, containing gradually increasing contextual information are presented to the user.

When the user moves the center of the screen on a sub image, a more detailed view for this orientation may be presented, by temporarily adding additional images next to this image. The new images can be introduced, because by moving the main visualization out of the view, additional space is gained for these images. For instance, moving the device to the left, screen-space to the left of the main view is made available and additional images are presented. The distances between the depicted images can then again be optimized.

To prevent cluttering of images, the number of images for the main view may be restricted, e.g., to nine, and for each sub view, e.g., to four.

Clustering. The data information in this application includes images tagged with GPS coordinates. The images are clustered by identifying similar content using the process described by X. Li, C. Wu, C. Zach, S. Lazebnik, and J.-M. Frahm in “Modeling and recognition of landmark image collections using iconic scene graphs”, In Proceedings of the 10th European Conference on Computer Vision: Part I, ECCV '08, pages 427-440, Berlin, Heidelberg, 2008. Springer-Verlag, which is incorporated herein by reference. There is one cluster C_{Li} per landmark. Using the GPS tag (i.e., the camera position) of the image relative to the GPS position of the landmark, the orientation of each image may be determined. Within a landmark cluster, sub-clusters C_{Oj} with similar orientation are computed using k-means.

Selection of representatives. Since a single image requires a rather high amount of screen-space, only small and simple icons at the location of each visible landmark are displayed. Furthermore the user is allowed to select one of the icons in order to query the images associated with the corresponding landmark.

For each landmark, representative images are presented to the left and right in screen space. They may be selected from the orientation subclusters C_{Oj} by their distance to the landmark. Images taken from a distance similar to the current distance of the user to the landmark are ranked higher than those which are further away or closer to the landmark.

Layout optimization. To evenly distribute representative images around a selected landmark, the differences between orientations of representatives are considered. We distribute representatives as evenly as possible around the object using the quality measure presented in Equation 3, where weights w₁, w₂, and w₃ control the bias of the parameters AvgNeighborAngleDist, which is the average angle distance to neighboring images, MinNeighborAngleDist, which is the minimum angle distance to a neighboring image, and MaxNeighborAngleDist, which is the maximum angle distance to a neighboring image.

QualityLayoutⱼ=(w₁*AvgNeighborAngleDist+w₂*MinNeighborAngleDist+w₃*MaxNeighborAngleDist). eq. 3

Two-Level Compact Photo Collections

For landmarks with a large number of associated images, a second level of representatives to each representative image. The first level of representatives may be provided as described above. The second level of representatives may be based on distance to the landmark. Thus, a first level of sub images arranged around the main image may show the landmark from other positions, i.e. orientations, and a second level of sub images from different distances.

To prevent cluttering of images, the number of images for the main view may be restricted, e.g., to nine, and for each sub view, e.g., to four.

Clustering. Within each of the orientation clusters, the second level of representatives is derived by searching for images presenting the object in similar detail. A measure of the amount of detail is derived only by computing the distance from the GPS location of an image to its corresponding landmark, since camera zoom information is not consistently available. Thus, for each subcluster C_{Oj}, k-means is used to create distance clusters C_{Dk} based on similar distance.

As described earlier, the geo-referenced presentation may be limited to, e.g., nine images, taken from different orientations, in the main view and four images showing the landmark at different distances, but from nearly the same orientation, in the detailed views. Accordingly, the number of output clusters is limited. When the cluster centers calculated by k-means lie too close together, the number of clusters may be further reduced and the k-means clustering reapplied. For sub-clusters C_{Oj}, the centers may be required to have a minimal distance of, e.g., approximately 40 degree, so that views are spread around the landmark. For distance clustering, the minimal distance between the cluster centers is calculated automatically, because distances need not be limited to a certain range. For example, the minimal distance between clusters may be simply an average distance between images, e.g., (d_max-d_min)/numCluster, where d_min is the distance between the landmark and the closest image, d_max is the distance between the landmark and the farthest image and numClusters is the current number of clusters for k-means.

Selection of representatives. From each distance cluster, we select the image with the smallest distance to cluster center. The result of the clustering step is a hierarchy where the root of the hierarchy contains all images of a landmark, the first level images clustered by orientation; the second level divides the first level further into clusters of images showing the landmark from different distances. The representative selection can then choose from either level of this hierarchy.

Layout optimization. Second-level representatives for geo-referenced photo collections show the object of interest in a variety of different details. In order to maximize the variation, the layout may be optimized using a measure of detail variation for a single level. To be able to show more interesting elements in more detail, detail variation is controlled using the number of images in the distance cluster C_{Dk}. Based on the assumption that more images indicate more interesting structure, a more detailed visualization for representatives from those orientations is favored. The distance quality criteria, discussed above, e.g., in equations 2 and 3 may be used to provide a combined value to be used as a quality measure for a layout during layout optimization.

Explosion Diagrams

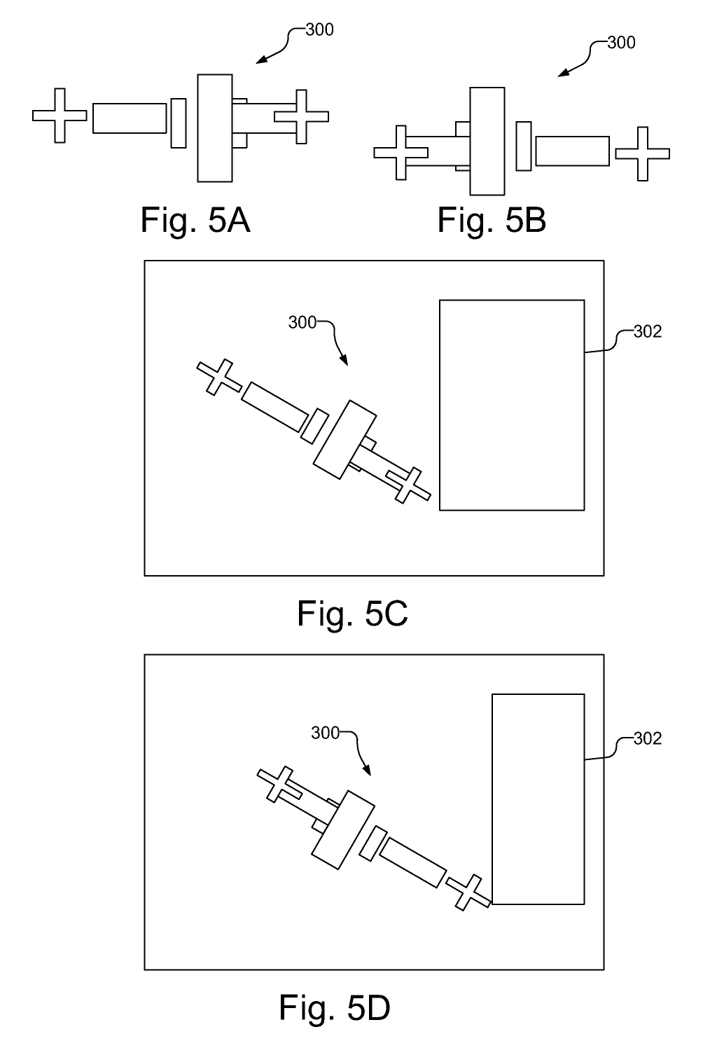

Compact explosion diagrams are a powerful visualization technique that uses screen space efficiently. However, in AR they can suffer from the fact that exploded objects are not depicted in isolation. In order to integrate compact explosion diagrams with AR, collision of scene elements have to be avoided. This can be achieved in real-time by pre-computing a set of layouts, which cover the space of possible layouts. FIGS. 5A and 5B, by way of example, illustrate a simple object 300 with different layouts, with the left portion exploded and the right portion exploded, respectively. During run-time optimization, the most compact, non-collision free layout is dynamically calculated and compared to the pre-computed layouts. The pre-computed layout which fits the available space best in terms of avoiding overlaps with scene elements is selected, as illustrated in FIG. 5C, which illustrates an image of the object 300 in an environment including another object 302. The pre-computed layout with the left portion exploded is selected to avoid the object 302. This approach does not always achieve collision-free layouts. Therefore, optionally moving real scene elements may be moved using AR to make room for the explosion diagram using the object displacement as illustrated in FIG. 5D.

To avoid random movements of the scene elements/objects, the movement can be constrained to certain surfaces or directions. The approach may be applied to 3D objects in the scene or 2D elements such as labels, elements of a heads up display, or elements of a marker when augmenting a model onto a marker. For example, elements located on a plane are forced to move on the respective plane. To avoid moving elements back into the explosion diagram, an additional directional force only allows moving the elements away from the explosion center.

Because moving a single element may destroy the overall relations between the elements, they may be connected by a force graph. Thus, moving one element also forces other elements connected by the graph to move. To avoid moving elements too far away from their original location, a force may be used, which pulls the element back to the original location. Through the use of the force graph, the modification of the scene layout may be constrained.

In general, the layout of an explosion diagram depends on the direction and the distance chosen for each part, to set it apart from its initial position. To reduce the mental load to reassemble an exploded object, explosion directions often follow mounting directions; therefore collisions between displaced parts are avoided. Explosion diagrams implement this feature by introducing relations between the parts of an assembly.

The relationships between parts of an explosion diagram also allow parts to follow related parts. This enables a part to move relative to its initial location in the assembly, which also reduces the number of mental transformations to reassemble the object. However, it is often not obvious which part best represents the initial location of another part. Thus, the explosion diagram may use the relationship between parts to reduce the number of translations of the elements in the diagram.

The data information provided in step 202 of FIG. 2 includes the relations between parts including a disassembly sequence, and explosion directions. The data relations between parts may be defined by computing the disassembly sequence. A relationship is set up for each exploded part and the biggest part in the remaining assembly it has contact with. To avoid collisions between exploding parts, the directions in which a part can be displaced are restricted to only those in which a part is not blocked by any other parts. In other words, parts which are unblocked in at least one direction are displaced, before displacing parts which are blocked in all directions. Thus, by removing the exploded parts from the assembly, blocking constraints are gradually removed, permitting previously blocked parts to be exploded in a subsequent iteration. Since the process gradually removes parts from the assembly, the set of directions for which a part is not blocked (and thus the set of potential explosion directions) depends on the set of previously removed parts. Consequently, the disassembly sequence directly influences the set of potential explosion directions.

Previous approaches to computing a disassembly sequence compute a sequence depending on how fast a part is able to escape the bounding box of the remaining parts in the assembly. However, since this approach does not comprise any information about the similarity between exploded parts, the resulting explosion layout does not ensure similar exploded views for similar assemblies. Consequently, information about the similarity of the parts in the sequence is encoded in the data. Similar parts are removed one after another, starting with the smallest. If no similar parts can be removed from the assembly, the current smallest part is selected. This strategy enables identification of relationships which subsequently allow smaller parts to follow bigger ones during explosion. Take note that, by computing a larger amount of similar explosion layouts, the system is able to choose a representative exploded view out of a larger set of similarly exploding assemblies.

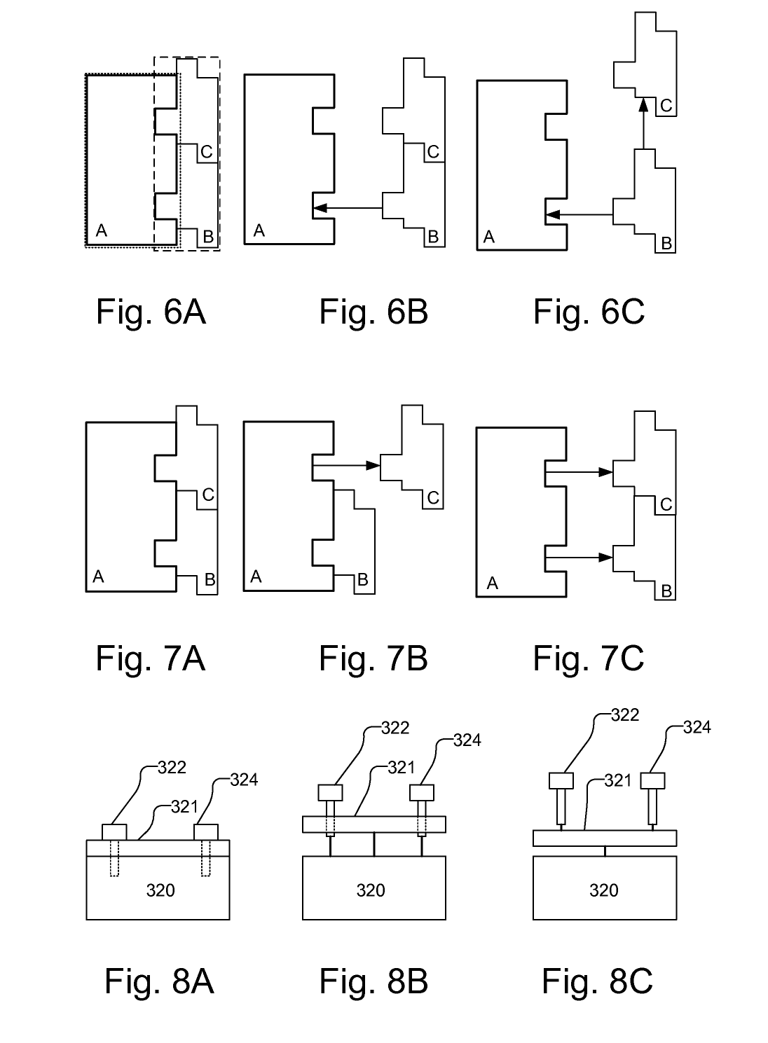

FIGS. 6A-6C illustrates a conventional disassembly sequence, and FIGS. 7A-7C illustrate the proposed disassembly sequence. FIGS. 6A-6C illustrate a disassembly sequence based on bounding box intersections (shown as dotted and dashed lines). The conventional process first removes part A (shown in FIG. 6B, before part B and part C are exploded (shown in FIG. 6C). With this strategy, relationships between part A and part B and subsequently between part C and part B will be set up. The resulting explosion layout is illustrated in FIG. 6C, and as can be seen, different explosion directions are been assigned to the similar parts B and C.

In contrast, FIGS. 7A-7C illustrate a sequence based on a comparison of the previously exploded part and dissembling all similar parts in the remaining assembly. As demonstrated in FIGS. 7A-7C, part C is removed (FIG. 7B) followed by removal of similar part B (FIG. 7C). Thus, both parts B and C have been displaced in the same direction and both parts have been related to the same part in the remaining assembly (part A).

Both strategies in FIGS. 6A-6C and FIGS. 7A-7C set up relationships between the current part and the bigger part. However, the proposed sequence shown in FIGS. 7A-7C removes similar parts one after the other, the remaining assemblies are identical for similar parts, with the exception of the previously removed part (which is similar to the current one). Since almost identical conditions exist for similar parts, the proposed process is able to set up similar relationships for those parts and the parts in the remaining assembly.

In addition to the initial assignment of relationships between parts, the relationships may be altered for penetrating elements in a stack. For example, the process may search for stacks of parts by searching for the elements which are located between the exploded part and the part that it is related to. If parts exist in-between and if these parts have an explosion direction with the currently removed part, the initial relationships are changed so that the exploded part is related to the closest part in the stack of parts in-between. This approach handles, for instance, screws that fix one part to another part, as illustrated in FIGS. 8A-8C. FIG. 8A illustrates a body with a removable element 321, which is attached with screws 322 and 324. FIG. 8B illustrates the relations between the various parts using a standard approach, in which the removable element 321 and the screws 322 and 324 are assigned a relation to the body 320 (as shown with the heavy lines). FIG. 8C, on the other hand, illustrates the current approach of assigning screws 322 and 324 with a relation to the removable element 321, while only the removable element 321 is assigned a relation to the body 320.

Additionally, the explosion direction may be computed in a non-directional blocking graph by computing blocking information between all pairs of parts. For each exploded part, the set of unblocked directions is determined by removing all blocked directions from the set of exiting 3D directions. All directions are represented by a unit sphere and blocked ones are removed by cutting away the half sphere with a cutting plane which is perpendicular to the direction of a blocking part. By iteratively cutting the sphere, using all blocking information from parts in contact with it, the remaining patch of the sphere represent all unblocked directions for a part. Thus, the explosion direction is output as a center of gravity from the remaining patch of the sphere.

In addition, the explosion distance is considered. If a subassembly appears multiple times in another subassembly, a hierarchy of subassemblies is introduced from which representatives are selected depending on an explosion style. If a style is chosen that explodes all related parts in a single cluster, a representative is selected out of a higher level group of parts. Therefore, the process should support an alignment of the distances of similar parts.

Since similar parts appear to be similarly large, the distance of displacement from the parent part may be set to be proportional to the size of the exploded part. Nevertheless, since a linear mapping may easily result in very distant parts, non-linear mapping, with a weighting factor k, may be used, as per equation 4.

Distance=SizeofPart*(1−k*RelativeSize²) 4

For parts which cannot be removed at all, a distance is computed where they can be moved until colliding with other parts.

The maximal distance a globally blocked part can be moved is computed by rendering both parts—the one which is about to be removed and the one which blocks its mounting direction into a texture. The camera is positioned at the vector along the explosion direction to point at the exploded part. In a vertex shader, the current model-view transformation matrix is used to transform each vertex into camera space. The corresponding fragment shader finally renders the location of each fragment in camera coordinates into the textures. By calculating the difference between the texture values, a map of distances between the fragments of both parts is obtained. The maximal distance a part can be removed, before it collides with the blocking part, is finally represented by the smallest difference between the values in the texture.

The similar elements are clustered (step 204 in FIG. 2) by performing a frequent subgraph (FSG) search on a graph representation of the assembly. The implemented approach is based on the gSpan algorithm of X. Yan, J. Han, in “gSpan: Graph-based substructure pattern mining”, Proceedings of the IEEE International Conference on Data Mining, IEEE Computer Society, Washington, D.C., USA, 2002, 4 pages, incorporated herein by reference, which uses depth-first search (DFS) codes to differentiate between two graphs. A DFS code describes the order in which parts of a subgraph have been visited. Two graphs are isomorphic if their DFS codes are equal and if their corresponding node labels (which represent the parts) match. By using DFS codes and node labels the implemented FSG algorithm finds non-overlapping sets S={G₁, . . . , Gₖ} of the largest subassemblies G contained in the graph. Other approaches than the gSpan algorithm may be used if desired, which are well known in the art.

The FSG requires the 3D model to be represented as a graph A_{g}, which contains all parts P={p₁, . . . pₙ}, with n being the amount of parts in the assembly. The parts of the assembly pᵢ (with i=1 . . . n) are mapped to an equal number of nodes of the graph. Undirected edges are created between nodes, when their corresponding parts are in contact.

Nodes of parts, which are similar to each other, receive the same label. The similar parts may be detected using the DESIRE shape descriptor proposed by D.V. Vranic in “DESIRE: A composite 3d-shape descriptor,” Proceedings of the IEEE International Conference on Multimedia and Expo, Amsterdam, The Netherlands, pp. 962-965. The descriptor computes a feature vector for each part which is used to compare shapes. Two parts are considered to be similar, if the 12-distance of their corresponding feature vectors falls below a desired threshold and the part sizes match. The result of the part comparison is a list of disjoint sets of similar parts Pₛ={pᵢ, . . . pₖ}, for i≠k, and i, k i<n, which is used to label the nodes of the graph A_{g}.

The entire graph A_{g} is provided for selection of a representative element. Initially, all nodes having a label which occurs only once in the graph are removed. These nodes represent parts, for which no similar parts exist (|Pₛ|=1). For each remaining set of similar parts Pₛ one set S₀ is created, containing |Pₛ| number of groups G₀, each containing a single part pεPₛ. The sets S₀ define the nodes at which the FSG search will start execution.

A recursive FSG mining procedure is applied on each of the sets S₀ and iterates through all input groups Gᵢ of an input set Sᵢ, in order to grow the groups Gᵢ to create similar groups of parts. In each iteration, a different group Gᵢ is chosen from Sᵢ to be the reference group Gᵣ. For the current group Gᵣ the set of neighbors Nr is retrieved for the node which was added last to the group Gᵣ. If all neighbors of the node added last have been processed, the neighbors of the previously added nodes are chosen. If all neighbors have been visited, the group Gᵣ cannot be extended further.

For each other Gᵢ≠Gᵣ the neighbors nᵢ similar to the ones in Nr are determined. Neighbors nᵢ are similar to each other if their labels and number of contact parts to the corresponding group Gᵢ are equal to the ones of the neighbor Nᵣ. Furthermore, the DFS codes and labels of the contact nodes contained in the groups must be equal. This similarity measure ensures that the found groups contain nodes, which have been visited in the same order and which have equal relations to their neighbors. After identifying similar neighbors for at least two groups Gᵢ and Gⱼ during the same iteration, a new set Sₙ is created. The new set contains the groups Gₙ₁=Gᵢ∪nᵢ and Gₙ₂=Gⱼ∪nⱼ, which now the original input groups extended by the similar neighbors. All groups for which similar neighbors exist are extended in the same way. Note, that for each set of similar neighbors a new set of groups is created and these groups differ only by one part from the groups of Sᵢ. Hence, by recursively calling the mining procedure on the new sets, a DFS is performed, growing these groups further. All groups Gᵢ which have been extended by a neighbor are removed from the input set Sᵢ, because these groups are then part of larger groups Gₙ. If |Sᵢ|≦1 for a set Sᵢ, all groups were extended and the set is deleted. However, the mining algorithm is applied again to any parts left in the set Sᵢ (if |Sᵢ|=1) to eventually extract smaller similar groups.

The FSG mining returns with the sets Sₒ of largest similar groups Gₒ. Overlapping output sets are resolved by keeping only one of the overlapping sets Sₒ and applying the FSG again to the set of A_{g}\Sₒ. This operation is repeated for all results, until the output sets Sₒ do not overlap anymore. One overlapping set is kept which contains the groups holding the most number of parts. If this measure is ambiguous, the set having the most groups is preferred. If this is still ambiguous the one containing the largest part is chosen.

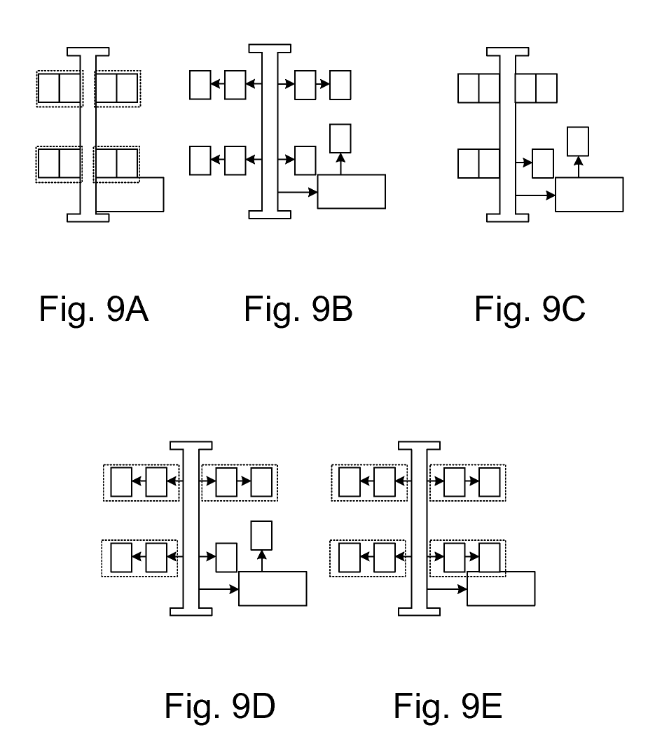

The process calculates similar subassemblies independent from the initial layout of the explosion diagram. However, even though the sequence generator specifically supports similar exploded views of similar subassemblies, if the neighborhoods of the similar subassemblies differ, the exploded views may be different. For example, FIG. 9A illustrates a model that includes one set of four similar subassemblies (identified by the dotted lines). Each of the subassemblies contains two parts. FIG. 9B illustrates an explosion diagram in which each single part has been displaced. As can be seen from the initial layout in FIG. 9A, the exploded view of the subassembly in the lower right corner is different from the other subassemblies due to the proximity of another element. If the exploded view of FIG. 9B is used, the resulting compact explosion diagram, as illustrate din FIG. 9C may lack a presentation of the other subassemblies.

To prevent representatives which explode differently to other similar subassemblies, the sets of similar subassemblies may be adjusted so that only similarly exploding subassemblies will be grouped together. Thus, the layout information may be used to modify the identification of similar subassemblies. Only those parts of the assembly are candidates for a group of similar subassemblies which have the same relations between the elements. FIG. 9D illustrates the result of such a restriction, where grouped subassemblies are once again identified with dotted lines. This strategy finds a set of only three subassemblies instead of the previously identified four similar subassemblies shown in FIG. 9A. Consequently, less subassemblies will be presented assembled which results in a layout which is not as compact as in the previous case.

In order to create a more compact explosion layout, without risking the selection of a representative that does not demonstrate the composition of other similar subassemblies, the layout of the explosion diagram may be modified instead of the information about the similarity of subassemblies. As illustrated in FIG. 9E, the layout is modified to prevent relationships with parts outside the subassembly. Only one relationship may be permitted between a part in the subassembly and the remaining 3D model.

The current approach differs from other approaches that may explode a manually defined group of parts as if it was a single element in the assembly, for example, interlocking groups are handed differently. Rather than splitting a subassembly, blocking parts are ignored, allowing subassemblies to remain connected. This could be at the cost of explosion diagrams which are not completely free from collisions. Nevertheless, it is believed that preventing such collisions is less important for the final compact explosion layout than a larger amount of explosions or a representative which does not demonstrate the composition of its associated subassemblies. In the case of a compact explosion diagram, it is more important to select a representative from a rather large set of similar subassemblies, which additionally all explode in a similar way.

Thus, an explosion diagram is computed that ensures similar explosion layouts of similar subassemblies as described above. However, for each part pᵢ, it is determined if it is a member of a subassembly Gᵢ which occurs multiple times in the model. If the algorithm is about to explode a part pᵢ which is a member of Gᵢ, a representative part pᵣ is chosen out of Gᵢ which we explode instead of pᵢ. The representative part pᵣ is defined as the biggest part in the subassembly Gᵢ which has at least one face in contact with at least one part of the remaining assembly, not considering other parts of the subassembly. In addition, the representative part pᵣ has to be removable in at least one direction without considering blocking constraints of parts of the same subassembly.

Even though pᵣ influences the explosion direction of the entire subassembly, the relationship between pᵣ and a part out of the remaining assembly may not be set. As each part may only be exploded once and as all frequent subassemblies should be exploded in the same way, the same part in each subassembly has to be chosen to set up the relation to the remaining assembly. Moreover, using the process described above, the small parts are to be exploded before the larger parts. Therefore, the biggest part is chosen in the assembly as the main part of the assembly and the biggest part in the remaining assembly which the subassembly has contact with is related to it.

If frequent subassemblies exist in an exploded subassembly, we cannot simply search for the bigger part in the main subassembly, because we also want to create a similar exploded view of all frequent subassemblies, even if they appear cascaded. Instead, a hierarchy of subassemblies is computed, as discussed below, before the biggest part is chosen from only the highest level of the hierarchy. The highest level ensures that no other part is similar to the chosen one and consequently no conflicting explosion layout can result. Note once again, by removing entire subassemblies in an unblocked direction of a single representative member, collisions between parts are ignored during explosion. Even though this may result in physically incorrect sequences to disassemble the object, subassemblies may be exploded independent of the overall model, which in turn enables to calculate a single explosion layout for all similar subassemblies.

After identifying frequent subassemblies and after computing an initial explosion layout, a compact representation is created by displacing only one representative group out of a set of similar groups. Thus, all of the subassemblies are evaluated and a representative subassembly is selected as described in step 206 in FIG. 2. To evaluate the subassemblies, a value of each subassembly to the explosion diagram is calculated based on its quality as the weighted sum of a set of measurements. Since the combination of representatives may influence the quality of a single subassembly, the selection is optimized based on the idea of threshold accepting. In the following, the parameters to value a subassembly is described, before the approach to combine representatives to the final compact explosion diagram is described.

The quality of a group of parts is defined as a combination of several criteria measurements. Therefore, for each subassembly, the local explosion is rendered, (which displaces only the parts of the subassembly and parts that block the group) and the following criteria values are computed. Size of footprint of the exploded group f, which is the size of the projected area of a part of the object in screen space. Size of footprint of all other similar groups without any displacements fᵣ describes how large similar, but unexploded subassemblies, will be presented. Explosion directions relative to current camera viewpoint a, is computed, e.g., as the dot product between the viewing vector and the explosion direction for each part. The explosion direction a is used as explosion directions that are similar to the viewing direction, are more difficult to read than those which explode more perpendicular to the viewing direction. The average value a for all parts in a subassembly may be used as the value for the group of parts within the subassembly. Visibility of parts of the exploded representative v is a relative measure determined, e.g., as a percentage from the current view by counting visible pixels of a part and those which are hidden. The final quality Qᵣ of an exploded view of a subassembly may consist of the weighted sum of these measured as shown in the following.

Qᵣ=f*f_{c}+v*v_{c}+(1−a)*a_{c}+fᵣ*f_{rc} eq. 5

The weights (f_{c}, v_{c}, a_{c}, f_{rc}) indicate the importance of each single parameter to describe the quality of the group. By differently scaling these parameters, the final presentation may be controlled. For example, an emphasis may be placed on the representative explosions, simultaneously showing similar subassemblies in the background as contextual information or, in contrast, the assembled parts of the compact explosion diagram may be displayed within the foreground while the exploded representatives are used to fill in contextual area. Either can be rendered by controlling a single weight, e.g., that scales up the impact of the size of the footprint of the representatives for the impact of the footprint of non-representatives fᵣ.

Even though the footprints of both, the representatives and the unexploded elements are important parameters to compact explosion diagrams, they may fail to create easily comprehensible presentations. Thus, scaling to place a high impact of the footprint of representatives by itself may turn out to be insufficient from certain points of view. For example, it may be desirable to scale up the impact of the explosion direction a, e.g., the angle between the view vector and the average direction of explosion for each representative to provide a more informative graphic.

Nevertheless, a high impact of only the explosion directions a leads to self-occlusions which again may hinder the understanding of the final presentation. However, even though self-occlusions are avoided within a single representative, global occlusion between different representatives are not controlled by this parameter.

Thus, there is no universal rule on which parameter to scale up or down to ensure comprehensible compact explosion diagrams. The weights can be used to direct the rendering towards the user's intention. The quality of the entire compact explosion diagram can only be controlled by taking combinations of explosions of representatives into account. By estimating the quality of an explosion of subassemblies independent from other explosions in the diagram, interdependent explosions and visual overlaps of representatives may change the quality of a representative explosion.

To avoid interferences of representatives with each other, an optimal combination of exploded groups may be performed using threshold accepting, which is a heuristic optimization strategy, in order to perform the layout optimization described in step 210 in FIG. 2 and in FIG. 4. In each step of the layout optimization process, the quality of a combination of representative explosions is evaluated by computing the sum of their scores after exploding all of the representatives.

After applying the FSG search to the graph A_{g} of the whole assembly, a list of sets which contain the largest available non-overlapping subassemblies has been discovered. However, the selected subassemblies may even contain other frequent subassemblies. By also identifying these subassemblies, a representative in multiple levels of the hierarchy may be selected, which in turn permits a further reduction in the number of displaced parts in a representative exploded view. To find frequent subassemblies within a previously determined subassembly, the FSG algorithm is applied recursively until no subassembly can be determined. When performing the FSG search on a set S of groups G, each group G is considered to be a separate graph to be mined for subassemblies. This means that a subsequent FSG search does not exceed the limits of the groups they are applied to.

By recursively applying the FSG search algorithm to a subassembly, a hierarchy of frequent subassemblies is retrieved. The groups of the detected sets and subsets are similar to each other, because their graph representations are isomorphic. However, subgroups of the same set may have different neighborhood relations to the group they are contained in. The reason for this is that the FSG mining algorithm removes all parts from the input graph, which do not have similar counterparts (for which only one label exists in the graph). Basically, this removes the contacts between any subgroups and the group they are contained in. By recovering this information, the hierarchy may be refined. This refinement permits selection of better representatives from a set, because similar groups are then also distinguishable by their neighborhoods. Therefore, we define that similar subgroups Gₗ not only must be similar in terms of graph isomorphism, but also the neighborhood to the groups Gₕ they are contained in has to be similar. The following process, which to searches for similar neighbors of groups of a set, may thus be used.

For each neighbor of a group the set of adjacent groups Eₙ is determined. Sets Eₙ of similar neighbors in different groups Gₕ are merged into the set Eₛ. Then, simple set operations are performed on the sets Eₛ to retrieve the common neighborhood for similar groups. For a representative Eᵣ from the sets of Eₛ, the following operations are performed in combination with each other Eₛ. First, the intersection E_{c}=Eᵣ\Eₛ is created. If |E_{c}|=|Eᵣ|, all groups share the same neighbor and the algorithm continues. Otherwise, the groups of Eᵣ share different neighbors. These groups are eliminated from Eᵣ (Eᵣ=Eᵣ\E_{c}). The algorithm continues until either all Eₛ have been considered, or |Eᵣ|=0. Those groups left in Eᵣ have similar neighborhoods. The algorithm finally terminates when all sets of Eₛ have been considered as representative set Eᵣ.

If a hierarchy of groups exists, representative exploded views may be selected using three different strategies. Representative parts may be selected from a single subassembly, or representative parts may be selected independently in different subassemblies of the same set. If explosions are restricted to a single hierarchy, the entire subassembly may be exploded or only a single representative in each level of the hierarchy may be exploded. Since it is an open question which strategy results in the perceptually best results, selecting a strategy may be reserved until runtime.

Even though the optimization process selects the best combination of representatives, some of the subassemblies may still be presented in a very small scale or highly occluded. These problems may be compensated for by rendering poor explosions of subassemblies from a more suitable point of view, thereby providing multi-perspective presentations of subassemblies. The renderings from secondary points of view allow small parts to be clearly displayed as well as reveal any occlusions, which appear from the main point of view.

To produce multi-perspective presentations of subassemblies, recognition of poorly displayed parts in the explosion diagram is performed by analyzing the final combination of representatives. Each quality parameter of a representative is evaluated individually and rendering is initiated from a secondary point of view if a quality parameter falls below an adjustable threshold. Because the footprint of the unexploded elements fᵣ can be neglected for a rendering from a secondary point of view of the representative itself, the impact of this parameter is scaled down by lowering its threshold to the minimum. However, even though the detection of poor explosions on the final rendering permits an increase in the effectiveness of the compact explosion diagram, poor elements of the representation are selected independent of representatives. In consequence, an optimal presentation may not be generated with respect to the visibility of representatives.

Poorly presented parts may be detected during the selection of representatives and the identification of candidates for a secondary rendering may be integrated into the overall layout optimization process. In each iteration of the optimization process, which evaluates a new combination of representatives, the visibility and the projected size of the explosion of every single subassembly is analyzed. If any of the evaluated parameters falls below an adjustable threshold, it is excluded from the quality calculation of the current combination of representatives. This strategy results in a quality value for a single combination of representatives, which represents only the relevant parts of the explosion diagram, but not those which will be presented from a more suitable point of view in a later stage in the rendering pipeline.

By integrating the selection of poorly visibly explosions of subassemblies into the combination of representatives, poorly presented subassemblies are excluded from the layout evaluation. Consequently, the final combination will be better for the representatives which are not presented from a secondary point of view. Another advantage is that this approach allows control over the number of secondary points of view and thus avoids clutter due to an excessive number of insets. However, the visibility of the already poorly presented subassemblies may become worse. Mentally relating secondary points of view for such cases may become very difficult, especially if the subassembly is completely occluded in the compact explosion diagram from the main point of view. Consequently, already optimized layouts are evaluated for poorly represented parts. Even though the combination of representative subassemblies may not be perfect, if the visibility of all parts of the assembly is taken into account, the resulting presentation will increase the capability of mentally linking the exploded view and the additional renderings. Therefore, multi-perspective renderings are supported best if poor parts of the presentations are detected after layout optimizations have been finished.

In order to present the renderings from secondary viewpoints as close as possible to their location in the compact explosion diagram, they are placed as annotations into the main explosion diagram. However, by spatially separating the presentations from different points of view, the user is required to put some effort into mentally linking the content of our renderings. To assist the user in this task, the viewpoint differences within both images may be restricted. The layout of subassemblies, for which additional views are rendered, is only allowed to change if it completely occluded within the main explosion layout. Otherwise, the layout which is visible from the secondary point of view will differ from the one in the main presentation making mentally relating structures to one another more difficult.

In addition, the offset between the second viewpoint and the main viewpoint may be restricted to an adjustable threshold. Calculating the secondary point of view independent of the main point of view can lead to presentations, which are difficult to read, for example, where the secondary point of view is offset by more than 90 degree to the main point of view. Mental linking may become difficult if the points of view have been offset too far. Therefore, secondary points of view are restricted to vary only within a certain range to the main point of view.

To compute a secondary point of view, contextual information is considered in addition to the subassembly itself. Otherwise, the rendering may not show any information besides the subassembly, which may also influence the ability to relate the renderings to one another. By adding weight to the measure describing the visibility of the rest, other parts are forced into the secondary view. However, since rendering a large amount of contextual elements may increase visual clutter, a new parameter that controls the amount of presented contextual elements may be introduced to the optimization process. Only those parts within direct contact with the representative subassembly may be considered as contextual information. The amount of contextual information is measured by using the size of its 2D projection, which is forced to be within a certain distance to an optimal value.

A quality measure which is based on the distance to the optimal amount of contextual information is provided below in equation 6. The absolute value of the difference between the threshold value contextTh and the normalized amount of pixel from contextual elements (contextPixel) describes the difference between the size of the 2D projection of current contextual information and the size of the ideal coverage with contextual information. Using the rule of thirds as the rule of for the layout, a threshold value of approximately 0.33 is used, which scores points of view highest if a third of the corresponding rendering is covered by contextual information.

contextQuality=(1−|contextTH−contextPixel|) eq. 6

To ensure an unobstructed view onto the explosion of the subassembly from a secondary point of view, a higher emphasis on the visibility as well as the direction of the explosion may be used during the computation of the quality of a representative from a certain point of view. Otherwise, close objects may occlude parts of the representative or representatives explode close to the viewing direction, making the secondary point of view less valuable.

Compact explosion diagrams which consist of a large number of small subassemblies may result in a cluttered presentation due to an equally large number of annotations. To make efficient use of the available screen-space, the number of annotations may be reduced, by combining similar ones into a single annotation. However, even if certain subassemblies are combined within a single secondary presentation, the amount of annotations is still unpredictable. Therefore importance values may be assigned based on the visibility of annotated parts. This allows selection of most important annotations until the available screen space is filled.

The process described so far is able to render a compact explosion diagram, which is annotated with renderings from additional points of view. Selecting the main viewpoint manually, may not lead to perfect results. To further automate the generation of compact explosion diagrams, the main point of view may be optimized as well. To render from a proper point of view, the values of different viewpoints are computed before selection of the one with the highest score. A set of candidate viewpoints is selected by sampling the bounding sphere of the object-of-interest. The orientations are derived for each candidate point of view by pointing the camera to the center of the bounding sphere. An adjustable threshold determines the number of samples on the sphere which are offset within an equal distant from each other.

In order to evaluate the quality of a point of view, the quality of the combination of representatives is computed using the parameters presented above. By selecting the view point with the highest score, the best point of view is selected for the representative explosions. However, while this process permits representation of the explosions from an optimal point of view, the object itself may not be sufficiently represented from the optimal point of view with respect to the quality parameter of its explosions. Typically, users select a point of view that maintains the natural up-orientation of an object, while simultaneously avoiding occlusions. In addition, rather low diagonal views are typically preferred, showing objects from familiar positions which contain as much information as possible. Accordingly, the set of possible points of view may be restricted and the user may be allowed to influence the viewpoint selection by setting the range of allowed views. Using this restriction, the point of view with the highest quality value selected, while simultaneously clearly presenting the object of interest.

While the present process produces compact explosion diagrams, which present certain subassemblies from secondary points of view in order to zoom into, to reveal occluded parts or to overcome ineffective directions of explosions, many different parameters must be evaluated, which require a high computational effort. Consequently, interactive frame rates for renderings are currently not possible. However, interactive compact explosion diagrams would offer two additional major advantages over traditional explosion diagrams. First, a very good presentation for interactive explorations is provided as well as a very effective initial presentation which can be further explored using traditional interaction techniques. Furthermore, the decreased space requirements of the compact explosion diagram allow presentation of explosion diagrams even on small screen devices such as tablets or smartphones.

Since a computation of the compact explosion diagram is not currently possible in real time, the best compact explosion diagram may be pre-computed from a sufficient set of representative points of view. During interaction, the view point which is closest to the current point of view is presented. To avoid flickering artifacts due to rapidly changing layouts, changes may be animated in the layout over time. To generate a finite amount of pre-computed compact explosion diagrams, the bounding sphere of the object of interest may be equidistantly sampled.

The compact explosion diagrams may be applied to real world objects using known rendering techniques. Conventional explosion diagrams require a rather high amount of screen space, requiring the user to stand farther away or the system to zoom out to present all parts in the explosion diagram, which often reduces the comprehension of the final presentation. This is especially problematic on small screen devices, which already have to cope with a small scale object presentations. In contrast, the compact explosion diagrams described herein offers a space efficient presentation of the assembly of an object, thereby permitting presentation of the object of interest in a much higher scale.

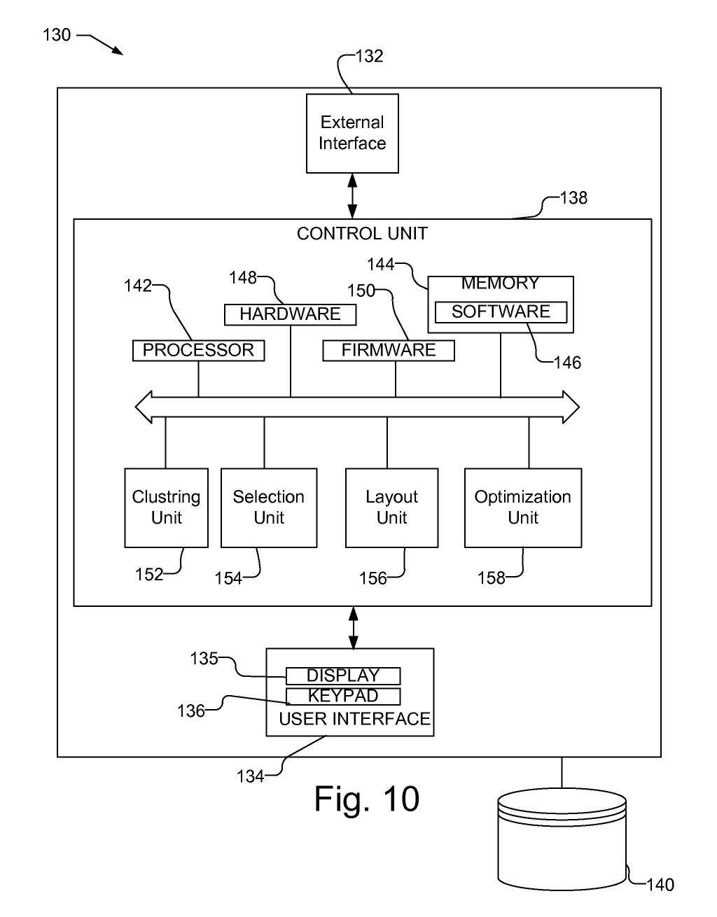

FIG. 10 is a block diagram of a server 130 capable of generating comprehensible layouts from a large database as described above. It should be understood that mobile platform 100 may similarly be capable of generating comprehensible layouts from a large database. Moreover, while FIG. 10 illustrates a single server 130, it should be understood that multiple servers may be used. The server 130 by way of example may be a standard PC with an Intel Core i7 processor (2.67 GHz) and a GeForce GTX480 graphics board. The server 130 includes an external interface 132, which is used to communicate with mobile platform 100 via the network 120 (FIG. 1). The external interface 132 may be a wired communication interface, e.g., for sending and receiving signals via Ethernet or any other wired format. Alternatively, if desired, the external interface 132 may be a wireless interface. The server 130 further includes a user interface 134 that includes, e.g., a display 135 and a keypad 136 or other input device. As illustrated, the server 130 is coupled to the database 140 that may be used for storing the data information and layouts.

The server 130 includes a server control unit 138 that is connected to and communicates with the external interface 132 and the user interface 134. The server control unit 138 accepts and processes data from the external interface 132 and the user interface 134 and controls the operation of those devices. The server control unit 138 may be provided by a processor 142 and associated memory/storage 144, which may include software 146, as well as hardware 148, and firmware 150. The server control unit 138 includes clustering unit 152 that clusters the data information, a selection unit 154 that evaluates each element in each cluster and selects a representative element, a layout unit 156 that generates layouts with the representative elements and an optimization unit 158 that optimizes the layout. The clustering unit 152, a selection unit 154, layout unit 156, and optimization unit 158 are illustrated separately and separate from processor 142 for clarity, but may be a combined and/or implemented in the processor 142 based on instructions in the software 146 which is run in the processor 142.

It will be understood as used herein that the processor 142, as well as the clustering unit 152, a selection unit 154, layout unit 156, and optimization unit 158 can, but need not necessarily include, one or more microprocessors, embedded processors, controllers, application specific integrated circuits (ASICs), digital signal processors (DSPs), and the like. The term processor is intended to describe the functions implemented by the system rather than specific hardware. Moreover, as used herein the terms “memory” and “storage” refers to any type of computer storage medium, including long term, short term, or other memory associated with the mobile platform, and is not to be limited to any particular type of memory or number of memories, or type of media upon which memory is stored.

The methodologies described herein may be implemented by various means depending upon the application. For example, these methodologies may be implemented in hardware 148, firmware 150, software 146, or any combination thereof. For a hardware implementation, the clustering unit 152, a selection unit 154, layout unit 156, and optimization unit 158 may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in memory 144 and executed by the processor 142. Memory may be implemented within or external to the processor 142.

If implemented in firmware and/or software, the functions may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, Flash Memory, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In addition, in order to apply compact visualizations to dynamic real world objects, updates after viewpoint changes have to be performed in real time and should be coherent over time. As discussed above, performing a full optimization in real time for every frame is currently not feasible for all applications, such as explosion diagrams. Accordingly, the optimized layout may be pre-computed, e.g., using server 130 (FIG. 1) for a given data set from a selected number of viewpoints, which are equidistantly distributed around the object of interest. In other words, the method illustrated in FIG. 2 is performed for a number of poses with respect to the object. To measure the amount of change between the layouts of two explosion diagrams, an explosion shape descriptor based on the Euclidean distance is used. In each explosion layout of an assembly there is a static center part, relative to which all other parts move. For compact explosion diagrams of the same assembly, the center part is always the same. To create the shape descriptor of an explosion layout the position of each part relative to the center part is calculated and stored in a feature vector. The difference between two layouts is measured as the Euclidean distance between the two feature vectors. The layouts for the plurality of poses are stored and at run time, the layout closest to the current viewpoint is selected. Flickering artifacts due to rapidly changing layouts as a pose between the camera and object are changed can be suppressed by smoothly animating a change in layout over time.

When changing the layout to accommodate a new viewpoint, a representative in a particular cluster of the new layout may differ from the previous representative. Even with smoothing animation, frequent changes can be disturbing. Therefore, pre-computed layouts in neighboring points of view are coordinated. Instead of aiming for the absolute best layout for each viewpoint in step 210 in FIG. 2, layouts for neighboring viewpoints are computed to be as similar as possible. The similarity is measured using the described shape descriptor. Thus, a layout is preferred if it has both high quality and is similar to its neighbors. Multiple neighboring points of view are considered and weighted by the inverse distance in viewpoint orientation space.

Finally, in interactive annotations, distracting changes over time mostly result from changing the order of labels. Accordingly, the difference between two annotation layouts may be defined using the amount of changes of label order. The original layout and label order is retained over time as the camera moves; only the label locations are adjusted. This ensures trivial continuity, but after strong viewpoint changes, the label anchor lines may start crossing in screen space. In order to resolve crossing lines, the anchor points of the annotations may be altered during optimization.

Using this method, points of view may be changed without heavily changing the layout. Once camera movement stops, a new optimal layout is selected from the set of pre-computed viewpoints as discussed above, and the change to the new layout is animated over time.

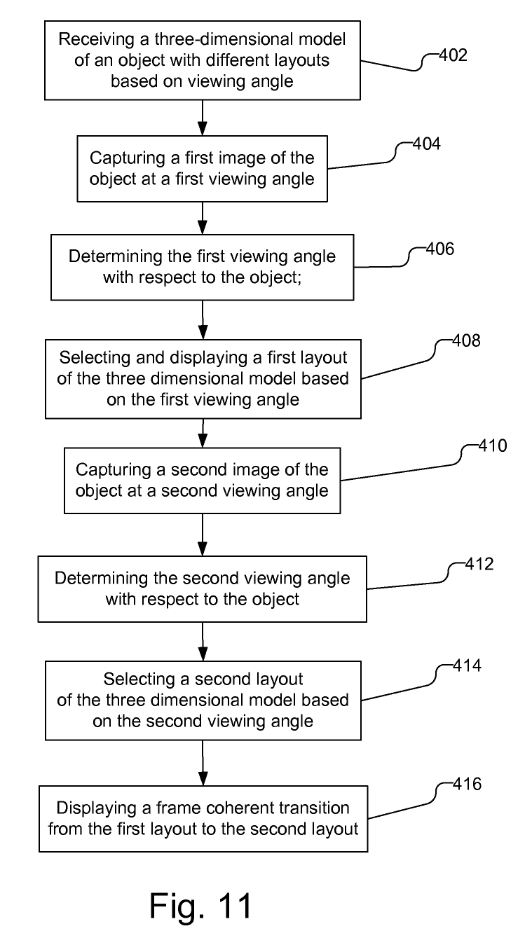

FIG. 11 is a flow chart illustrating a method of displaying dynamic layouts as the pose between the mobile platform 100 and the object is changed. As illustrated, a three-dimensional model of an object with different layouts based on viewing angle is received (402). For example, the mobile platform 100 may receive the three-dimensional model from server 130 or if the mobile platform 100 is of generating such a three-dimensional model, the model is received from internal storage in mobile platform 100. The three-dimensional model may include annotations, an explosion diagram, or pictures, as described above, or may include any other desired information. A first image of the object is captured at a first viewing angle (404) and the first viewing angle with respect to the object is determined (406). The viewing angle with respect to the object may be determined using any desired pose estimation technique, which is conventionally used in AR type applications. Examples of pose estimation techniques include visual tracking, for example using natural features, fiducial markers, or 3D object tracking, or sensor-based tracking, for example magnetic or infrared sensors which estimate the pose from devices attached to the camera. A three-dimensional model having a first layout is selected and displayed based on the first viewing angle (408). In other words, the first layout is selected as having the closest match to the first viewing angle. The three-dimensional model with the first layout may be displayed over the first image of the object. A second image of the object is captured at a second viewing angle (410) and the second viewing angle with respect to the object is determined (412). A second layout of the three-dimensional model is selected based on the second viewing angle (414). A frame coherent transition from the first layout to the second layout is displayed (416). By way of example, the frame coherent transition may be displayed as an animation of changes between the first layout and the second layout. Additionally, the method may include determining that movement has stopped prior to displaying the frame coherent transition from the first layout to the second layout.

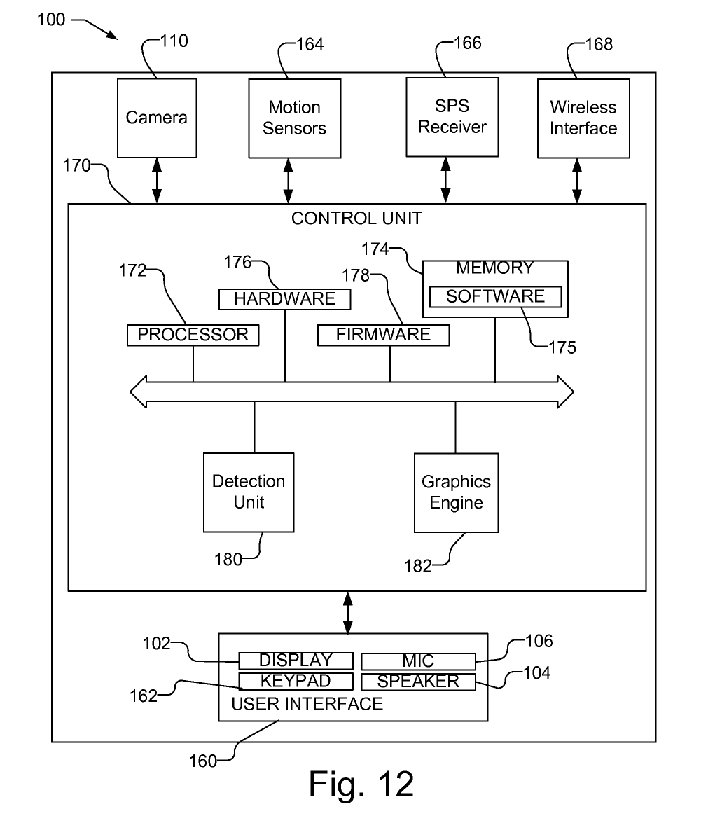

FIG. 12 is a block diagram of mobile platform 100 capable of displaying dynamic layouts as the pose changes between the mobile platform and a target object as described above. As illustrated, the mobile platform 100 includes the camera 110 as well as a user interface 160 that includes the display 102 capable of displaying images captured by the camera 110 and generated layouts of the three-dimensional model. The user interface 160 may also include a keypad 162 or other input device through which the user can input information into the mobile platform 100. If desired, the keypad 162 may be obviated by integrating a virtual keypad into the display 102 with a touch sensor. The user interface 160 may also include a microphone 106 and speaker 104, e.g., if the mobile platform is a cellular telephone.

The mobile platform 100 may optionally include additional features that may be helpful for AR applications, such as a motion sensor 164 including, e.g., accelerometers, magnetometer, gyroscopes, or other similar motion sensing elements, and a satellite positioning system (SPS) receiver 166 capable of receiving positioning signals from an SPS system. An SPS system of transmitters is positioned to enable entities to determine their location on or above the Earth based, at least in part, on signals received from the transmitters. In a particular example, such transmitters may be located on Earth orbiting satellite vehicles (SVs), e.g., in a constellation of Global Navigation Satellite System (GNSS) such as Global Positioning System (GPS), Galileo, Glonass or Compass or other non-global systems. Thus, as used herein an SPS may include any combination of one or more global and/or regional navigation satellite systems and/or augmentation systems, and SPS signals may include SPS, SPS-like, and/or other signals associated with such one or more SPS. Mobile platform 100 further includes a wireless interface 168, e.g., for communicating with server 130 via network 120 as described above. Of course, mobile platform 100 may include other elements unrelated to the present disclosure.

The mobile platform 100 also includes a control unit 170 that is connected to and communicates with the camera 110, user interface 160, along with other features, such as the motion sensor 164, SPS receiver 166, and wireless interface 168. The control unit 170 accepts and processes data from the camera 110 and controls the display 102 in response, as discussed above. The control unit 170 may be provided by a processor 172 and associated memory 174, hardware 176, software 175, and firmware 178. The mobile platform 100 may include a detection unit 180 for determining the viewpoint of the camera 110 with respect to an imaged object as described above. The control unit 170 may further include a graphics engine 182, which may be, e.g., a gaming engine, to render desired data in the display 102 including frame coherent transitions between viewpoints. The detection unit 180 and graphics engine 182 are illustrated separately and separate from processor 172 for clarity, but may be a single unit and/or implemented in the processor 172 based on instructions in the software 175 which is run in the processor 172. It will be understood as used herein that the processor 172, as well as one or more of the detection unit 180 and graphics engine 182 can, but need not necessarily include, one or more microprocessors, embedded processors, controllers, application specific integrated circuits (ASICs), digital signal processors (DSPs), and the like. The term processor is intended to describe the functions implemented by the system rather than specific hardware. Moreover, as used herein the term “memory” refers to any type of computer storage medium, including long term, short term, or other memory associated with the mobile platform, and is not to be limited to any particular type of memory or number of memories, or type of media upon which memory is stored.

The methodologies described herein may be implemented by various means depending upon the application. For example, these methodologies may be implemented in hardware 176, firmware 178, software 175, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in memory 174 and executed by the processor 172. Memory may be implemented within or external to the processor 172.

If implemented in firmware and/or software, the functions may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, Flash Memory, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Although the present invention is illustrated in connection with specific embodiments for instructional purposes, the present invention is not limited thereto. Various adaptations and modifications may be made without departing from the scope of the invention. Therefore, the spirit and scope of the appended claims should not be limited to the foregoing description.

What is claimed is:

1. A method comprising:
receiving data information to be displayed;
clustering the data information into groups of similar elements;
calculating a quality measure for each element in each group;
generating a layout with a representative element from each group selected based on the quality measure;
optimizing the layout by replacing the representative element from at least one group based on the quality measure to produce a final layout; and
providing the final layout to be displayed.

2. The method of claim 1, wherein optimizing the layout comprises:
repeatedly generating different layouts with different selected representative elements from each group;
calculating global quality measures for the different layouts; and
selecting the final layout based on the global quality measures for the different layouts.

3. The method of claim 1, wherein optimizing the layout comprises:
calculating a global quality measure for the layout;
calculating a sum of quality measures for each representative element in the layout;
replacing a first representative element from a first group when the global quality measure is less than the sum of quality measures to form a current layout;
calculating a new global quality measure for the current layout;
replacing a second representative element from a second group in the current layout when a difference between the global quality measure and the new global quality measure is not greater than a threshold; and
replacing the second representative element from the second group in the layout when the difference between the global quality measure and the new global quality measure is greater than the threshold.

4. The method of claim 1, wherein the quality measure for each element in each group is based on a predicted comprehensibility in a display.

5. The method of claim 1, wherein the data information comprises one of a photo collection, an explosion diagram; and textual annotations.

6. The method of claim 1, wherein the data information comprises an explosion diagram of a three-dimensional (3D) model and wherein:
clustering the data information into groups of similar elements comprises identifying and grouping recurring subassemblies in the 3D model, each subassembly having multiple parts;
calculating the quality measure for each element in each group comprises determining criteria values for visibility for each element based on viewing angle, a first projected size of each element after being exploded, an explosion direction for each element relative to the viewing angle, and a second projected size of unexploded elements and determining a weighted sum of the criteria values; and
optimizing the layout comprises permuting through different combinations of subassemblies to determine a final combination of subassemblies.

7. The method of claim 6, wherein calculating the quality measure for each element in each group, generating the layout, and optimizing the layout are performed for multiple viewing angles.

8. The method of claim 1, wherein the data information comprises textual annotations for a three-dimensional structure, the method further comprising:
calculating shape descriptors for each part of the three-dimensional structure; and
identifying semantics of each part using the shape descriptors;
wherein:
clustering the data information into groups of similar elements comprises identifying and grouping redundant textual annotations by comparing at least one of the shape descriptors and the semantics;
calculating the quality measure for each element in each group comprises determining criteria values including a first distance to a denoted object, a second distance to adjacent annotations, a third distance between anchor points, a fourth distance from an optimal position, and a visibility of parts of the denoted object and determining a weighted sum of the criteria values;
generating the layout comprises arranging non-redundant textual annotations with a best representative textual annotation from each cluster based on the third distance to anchor point and the visibility of parts; and
optimizing the layout comprises permuting through different combinations of textual annotations and determining a final combination based on the second distance to adjacent annotations, the third distance to anchor points.

9. The method of claim 8, wherein the textual annotations are for the three-dimensional structure and wherein calculating the quality measure for each element in each group, generating the layout, and optimizing the layout are performed for multiple viewing angles.

10. The method of claim 8, wherein the textual annotations are for images.

11. The method of claim 1, wherein the data information comprises geo-referenced photographs, wherein:
clustering the data information into groups of similar elements comprises identifying and grouping images of similar objects; identifying and grouping into subclusters images with similar orientations with respect to an object imaged; and identifying and grouping into additional subclusters images with similar distances to the object imaged; and
calculating the quality measure for each element in each group comprises determining a current orientation and distance from the object imaged and determining quality based on a difference between the current orientation and distance and an orientation and distance in the subclusters.

12. An apparatus comprising:
memory storing data information to be displayed;
a processor coupled the memory, the processor configured to cluster the data information into groups of similar elements, calculate a quality measure for each element in each group, generate a layout with a representative element from each group selected based on the quality measure, optimize the layout by being configured to replace the representative element from at least one group based on the quality measure to produce a final layout, and to store the final layout to be displayed.

13. The apparatus of claim 12, wherein the processor is configured to optimize the layout by being configured to repeatedly generate different layouts with different selected representative elements from each group, calculate global quality measures for the different layouts, and select the final layout based on the global quality measures for the different layouts.

14. The apparatus of claim 12, wherein the processor is configured to optimize the layout by being configured to calculate a global quality measure for the layout; calculate a sum of quality measures for each representative element in the layout; replace a first representative element from a first group when the global quality measure is less than the sum of quality measures to form a current layout; calculate a new global quality measure for the current layout; replace a second representative element from a second group in the current layout when a difference between the global quality measure and the new global quality measure is not greater than a threshold; and replace the second representative element from the second group in the layout when the difference between the global quality measure and the new global quality measure is greater than the threshold.

15. The apparatus of claim 12, wherein the quality measure for each element in each group is based on a predicted comprehensibility in a display.

16. The apparatus of claim 12, wherein the data information comprises one of a photo collection, an explosion diagram; and textual annotations.

17. The apparatus of claim 12, wherein the data information comprises an explosion diagram of a three-dimensional (3D) model and wherein the processor is configured to:
cluster the data information into groups of similar elements by being configured to identify and group recurring subassemblies in the 3D model, each subassembly having multiple parts;
calculate the quality measure for each element in each group being configured to determine criteria values for visibility for each element based on viewing angle, a first projected size of each element after being exploded, an explosion direction for each element relative to the viewing angle, and a second projected size of unexploded elements and determine a weighted sum of the criteria values; and
optimize the layout by being configured to permute through different combinations of subassemblies to determine a final combination of subassemblies.

18. The apparatus of claim 17, wherein the processor is configured to calculate the quality measure for each element in each group, generate the layout, and optimize the layout for multiple viewing angles.

19. The apparatus of claim 12, wherein the data information comprises textual annotations for a three-dimensional structure, and wherein the processor is further configured to calculate shape descriptors for each part of the three-dimensional structure; and identify semantics of each part using the shape descriptors; and wherein the processor is configured to:
cluster the data information into groups of similar elements by being configured to identify and group redundant textual annotations by comparing at least one of the shape descriptors and the semantics;
calculate the quality measure for each element in each group by being configured to determine criteria values including a first distance to a denoted object, a second distance to adjacent annotations, a third distance between anchor points, a fourth distance from an optimal position, and a visibility of parts of the denoted object and determine a weighted sum of the criteria values;
generate the layout by being configured to arrange non-redundant textual annotations with a best representative textual annotation from each cluster based on the third distance to anchor point and the visibility of parts; and
optimize the layout by being configured to permute through different combinations of textual annotations and determine a final combination based on the second distance to adjacent annotations, the third distance to anchor points.

20. The apparatus of claim 19, wherein the textual annotations are for the three-dimensional structure and wherein the processor is configured to calculate the quality measure for each element in each group, generate the layout, and optimize the layout for multiple viewing angles.

21. The apparatus of claim 19, wherein the textual annotations are for images.

22. The apparatus of claim 12, wherein the data information comprises geo-referenced photographs, and wherein the processor is configured to:
cluster the data information into groups of similar elements by being configured to identify and group images of similar objects; identify and group into subclusters images with similar orientations with respect to an object imaged; and identify and group into additional subclusters images with similar distances to the object imaged; and
calculate the quality measure for each element in each group evaluate by being configured to determine a current orientation and distance from the object imaged and determine quality based on a difference between the current orientation and distance and an orientation and distance in the subclusters.

23. An apparatus comprising:
means for receiving data information to be displayed;
means for clustering the data information into groups of similar elements;
means for calculating a quality measure for each element in each group;
means for generating a layout with a representative element from each group selected based on the quality measure;
means for optimizing the layout by replacing the representative element from at least one group based on the quality measure to produce a final layout; and
means for providing the final layout to be displayed.

24. The apparatus of claim 23, wherein the means for optimizing the layout comprises:
means for repeatedly generating different layouts with different selected representative elements from each group;
means for calculating global quality measures for the different layouts; and
means for selecting the final layout based on the global quality measures for the different layouts.

25. The apparatus of claim 23, wherein the means for optimizing the layout comprises:
means for calculating a global quality measure for the layout;
means for calculating a sum of quality measures for each representative element in the layout;
means for replacing a first representative element from a first group when the global quality measure is less than the sum of quality measures to form a current layout;
means for calculating a new global quality measure for the current layout;
means for replacing a second representative element from a second group in the current layout when a difference between the global quality measure and the new global quality measure is not greater than a threshold; and
means for replacing the second representative element from the second group in the layout when the difference between the global quality measure and the new global quality measure is greater than the threshold.

26. The apparatus of claim 23, wherein the quality measure for each element in each group is based on a predicted comprehensibility in a display.

27. The apparatus of claim 23, wherein the data information comprises one of a photo collection, an explosion diagram; and textual annotations.

28. The apparatus of claim 23, wherein the data information comprises an explosion diagram of a three-dimensional (3D) model and wherein:
the means for clustering the data information into groups of similar elements comprises means for identifying and grouping recurring subassemblies in the 3D model, each subassembly having multiple parts;
the means for calculating the quality measure for each element in each group comprises means for determining criteria values for visibility for each element based on viewing angle, a first projected size of each element after being exploded, an explosion direction for each element relative to the viewing angle, and a second projected size of unexploded elements and means for determining a weighted sum of the criteria values; and
the means for optimizing the layout comprises means for permuting through different combinations of subassemblies to determine a final combination of subassemblies.

29. The apparatus of claim 28, wherein the means for calculating the quality measure for each element in each group, means for generating the layout, and means for optimizing the layout are for multiple viewing angles.

30. The apparatus of claim 23, wherein the data information comprises textual annotations for a three-dimensional structure, the apparatus further comprising:
means for calculating shape descriptors for each part of the three-dimensional structure; and
means for identifying semantics of each part using the shape descriptors;
wherein:
the means for clustering the data information into groups of similar elements comprises means for identifying and grouping redundant textual annotations by comparing at least one of the shape descriptors and the semantics;
the means for calculating the quality measure for each element in each group comprises means for determining criteria values including a first distance to a denoted object, a second distance to adjacent annotations, a third distance between anchor points, a fourth distance from an optimal position, and a visibility of parts of the denoted object and means for determining a weighted sum of the criteria values;
the means for generating the layout comprises means for arranging non-redundant textual annotations with a best representative textual annotation from each cluster based on the third distance to anchor point and the visibility of parts; and
the means for optimizing the layout comprises means for permuting through different combinations of textual annotations and determining a final combination based on the second distance to adjacent annotations, the third distance to anchor points.

31. The apparatus of claim 30, wherein the textual annotations are for the three-dimensional structure and wherein the means for calculating the quality measure for each element in each group, the means for generating the layout, and the means for optimizing the layout are for multiple viewing angles.

32. The apparatus of claim 30, wherein the textual annotations are for images.

33. The apparatus of claim 23, wherein the data information comprises geo-referenced photographs, wherein:
the means for clustering the data information into groups of similar elements comprises means for identifying and grouping images of similar objects; means for identifying and grouping into subclusters images with similar orientations with respect to an object imaged; and means for identifying and grouping into additional subclusters images with similar distances to the object imaged; and
the means for calculating the quality measure for each element in each group comprises means for determining a current orientation and distance from the object imaged and means for determining quality based on a difference between the current orientation and distance and an orientation and distance in the subclusters.

34. A non-transitory computer-readable medium including program code stored thereon, comprising:
program code to cluster data information to be displayed into groups of similar elements;
program code to calculate a quality measure for each element in each group; program code to generate a layout with a representative element from each group selected based on the quality measure;
program code to optimize the layout by being configured to replace the representative element from at least one group based on the quality measure to produce a final layout; and
program code to store the final layout to be displayed.

35. The non-transitory computer-readable medium of claim 34, wherein the program code to optimize the layout comprises:
program code to calculate a global quality measure for the layout;
program code to calculate a sum of quality measures for each representative element in the layout;
program code to replace a first representative element from a first group when the global quality measure is less than the sum of quality measures to form a current layout;
program code to calculate a new global quality measure for the current layout;
program code to replace a second representative element from a second group in the current layout when a difference between the global quality measure and the new global quality measure is not greater than a threshold; and
program code to replace the second representative element from the second group in the layout when the difference between the global quality measure and the new global quality measure is greater than the threshold.

36. The non-transitory computer-readable medium of claim 34, wherein the data information comprises one of a photo collection, an explosion diagram; and textual annotations.

37. The non-transitory computer-readable medium of claim 34, wherein the data information comprises an explosion diagram of a three-dimensional (3D) model and wherein:
the program code to cluster the data information into groups of similar elements comprises program code to identify and group recurring subassemblies in the 3D model, each subassembly having multiple parts;
the program code to calculate the quality measure for each element in each group comprises program code to determine criteria values for visibility for each element based on viewing angle, a first projected size of each element after being exploded, an explosion direction for each element relative to the viewing angle, and a second projected size of unexploded elements and program code to determine a weighted sum of the criteria values; and
the program code to optimize the layout comprises program code to permute through different combinations of subassemblies to determine a final combination of subassemblies.

38. The non-transitory computer-readable medium of claim 34, wherein the data information comprises textual annotations for a three-dimensional structure, further comprising:
program code to calculate shape descriptors for each part of the three-dimensional structure; and
program code to identify semantics of each part using the shape descriptors; and wherein:
the program code to cluster the data information into groups of similar elements comprises program code to identify and group redundant textual annotations by comparing at least one of the shape descriptors and the semantics;
the program code to calculate the quality measure for each element in each group comprises program code to determine criteria values including a first distance to a denoted object, a second distance to adjacent annotations, a third distance between anchor points, a fourth distance from an optimal position, and a visibility of parts of the denoted object and program code to determine a weighted sum of the criteria values;
the program code to generate the layout comprises program code to arrange non-redundant textual annotations with a best representative textual annotation from each cluster based on the third distance to anchor point and the visibility of parts; and
the program code to optimize the layout comprises program code to permute through different combinations of textual annotations and determine a final combination based on the second distance to adjacent annotations, the third distance to anchor points.

39. The non-transitory computer-readable medium of claim 34, wherein the data information comprises geo-referenced photographs, and wherein:
the program code to cluster the data information into groups of similar elements comprises program code to identify and group images of similar objects; program code to identify and group into subclusters images with similar orientations with respect to an object imaged; and program code to identify and group into additional subclusters images with similar distances to the object imaged; and
the program code to calculate the quality measure for each element in each group comprises program code to determine a current orientation and distance from the object imaged and program code to determine quality based on a difference between the current orientation and distance and an orientation and distance in the subclusters.

40. A method comprising:
receiving a three-dimensional model of an object with different layouts based on viewing angle;
capturing a first image of the object at a first viewing angle;
determining the first viewing angle with respect to the object;
selecting and displaying a first layout of the three-dimensional model based on the first viewing angle;
capturing a second image of the object at a second viewing angle;
determining the second viewing angle with respect to the object;
selecting a second layout of the three-dimensional model based on the second viewing angle; and
displaying a frame coherent transition from the first layout to the second layout.

41. The method of claim 40, wherein the three-dimensional model with the first layout is displayed over the first image of the object.

42. The method of claim 40, wherein displaying the frame coherent transition from the first layout to the second layout comprises displaying an animation of changes between the first layout and the second layout.

43. The method of claim 40, further comprising determining that movement has stopped prior to displaying the frame coherent transition from the first layout to the second layout.

44. The method of claim 40, wherein the three-dimensional model comprises an explosion diagram.

45. The method of claim 40, wherein the three-dimensional model comprises textual annotations for a three-dimensional structure.

46. A mobile platform comprising:
a camera for imaging an object;
memory for storing a three-dimensional model of the object with different layouts based on viewing angle;
a display;
a processor coupled to the camera, the memory, and the display, the processor configured to determine a first viewing angle with respect to the object from a first image of the object captured by the camera, select a first layout of the three-dimensional model based on the first viewing angle and causing the display to display the first layout, determine a second viewing angle with respect to the object from a second image of the object captured by the camera, select a second layout of the three-dimensional model based on the second viewing angle and causing the display to display a frame coherent transition from the first layout to the second layout.

47. The mobile platform of claim 46, wherein the three-dimensional model with the first layout is displayed over the first image of the object.

48. The mobile platform of claim 46, wherein the processor causes the display to display an animation of changes between the first layout and the second layout as the frame coherent transition from the first layout to the second layout.

49. The mobile platform of claim 46, the processor further being configured to determine that movement has stopped prior to causing the display to display the frame coherent transition from the first layout to the second layout.

50. The mobile platform of claim 46, wherein the three-dimensional model comprises an explosion diagram.

51. The mobile platform of claim 46, wherein the three-dimensional model comprises textual annotations for a three-dimensional structure.

52. A mobile platform comprising:
means for receiving a three-dimensional model of an object with different layouts based on viewing angle;
means for capturing a first image of the object at a first viewing angle;
means for determining the first viewing angle with respect to the object;
means for selecting and displaying a first layout of the three-dimensional model based on the first viewing angle;
means for capturing a second image of the object at a second viewing angle;
means for determining the second viewing angle with respect to the object;
means for selecting a second layout of the three-dimensional model based on the second viewing angle; and
means for displaying a frame coherent transition from the first layout to the second layout.

53. The mobile platform of claim 52, wherein the three-dimensional model with the first layout is displayed over the first image of the object.

54. The mobile platform of claim 52, wherein the means for displaying the frame coherent transition from the first layout to the second layout comprises means for displaying an animation of changes between the first layout and the second layout.

55. The mobile platform of claim 52, further comprising means for determining that movement has stopped, wherein the means for displaying does not display the frame coherent transition until movement has stopped.

56. A non-transitory computer-readable medium including program code stored thereon, comprising:
program code to determine a viewing angle with respect to an object from a first image of the object captured by a camera;
program code to select a layout of a three-dimensional model based on the viewing angle;
program code to cause the display to display the layout selected based on the viewing angle; and
program code to display to display a frame coherent transition between different layouts.

57. The non-transitory computer-readable medium of claim 56, wherein the program code to display to display the frame coherent transition between different layouts comprises program code to display an animation of changes between the different layouts.
